(19) United States
(12) Patent Application Publication
(10) Pub. No.: US 2014/0026537 A1
(43) Pub. Date: Jan. 30, 2014

(54) Multiple Use Hybrid Rocket Motor

(71) Applicants: Shannon D. Eilers, Logan, UT (US); Stephen Whitmore, Logan, UT (US); Zachary Peterson, Chincoteague, VA (US)

(72) Inventors: Shannon D. Eilers, Logan, UT (US); Stephen Whitmore, Logan, UT (US); Zachary Peterson, Chincoteague, VA (US)

(73) Assignee: UTAH STATE UNIVERSITY, North Logan, UT (US)

(21) Appl. No.: 13/953,877

(22) Filed: Jul. 30, 2013

Related U.S. Application Data
(60) Provisional application No. 61/677,254, filed on Jul. 30, 2012.
(60) Provisional application No. 61/677,266, filed on Jul. 30, 2012.
(60) Provisional application No. 61/677,418, filed on Jul. 30, 2012.
(60) Provisional application No. 61/677,426, filed on Jul. 30, 2012.
(60) Provisional application No. 61/677,298, filed on Jul. 30, 2012.

(51) Int. Cl. F02K 9/24

(52) U.S. Cl. CPC F02K 9/24
USPC 60/251; 264/3.1

(57) ABSTRACT

The Multiple Use Plug Hybrid (for) Nanosats (“MUPHyN”) prototype thruster is being developed to fill a niche application for NanoSat scale spacecraft propulsion. The MUPHyN thruster uses safe-handling and inexpensive nitrous oxide (N₂0) and acrylonitrile-butadiene-styrene (ABS) as propellants. The MUPHyN thruster can provide an enhanced propulsive capability that will enable multiple NanoSats to be independently repositioned after deployment from the parent launch vehicle. Because the environmentally benign propellants are mixed only within the combustion chamber once the ignition is initiated, the system is inherently safe and can be piggy-backed on a secondary payload with no overall mission risk increase to the primary payload.

### RELATED APPLICATIONS

This application claims the benefit under 35 U.S.C. §119(e) of U.S. Provisional Application Nos. 61/677,254, 61/677,266, 61/677,418, 61/677,426, and 61/677,298, all filed Jul. 30, 2012, and all hereby incorporated by reference herein in their entirety.

### GOVERNMENT SPONSORED RESEARCH

This invention was made with government support under contract NSSC NNX09AW08A, awarded by NASA. The government has certain rights in the invention.

### TECHNICAL FIELD

The present disclosure relates to hybrid rocket motors, and more specifically, a multiple-use hybrid rocket motor.

### BACKGROUND

There exists an emerging scientific, military, and commercial interest in constellations of small, inexpensive nano-scale spacecraft. Of particular interest are “NanoSats” that can be flown as secondary payloads. A particular NanoSat design that is seeing increasing popularity is a 10 by 10 cm cube form-factor (1U). Multiple 1U cubes are coupled together to form “CubeSats.” Standard deployment systems for CubeSats as large as 6-U have currently certified for fight on several USA and European launch vehicles.

If these small spacecraft can be deployed and organized into constellations to collectively perform a coordinated mission, they present distinct advantages not available to single larger-scale spacecraft that must be deployed one launch at a time. The distributed nature of this small spacecraft “swarm” offers a significant increase in mission reliability. A large constellation has built-in redundancy. Advanced space missions enabled by these orbiting constellations include: (1) Sun-Earth Connection science missions that collect simultaneous multi-point spatial and temporal thermospheric and ionospheric data to analyze the causes and effects of space weather on the Earth, (2) persistent surveillance of Earth science targets, and (3) beyond-line of sight (BLOS) surface communications. For advanced mission concepts, providing a capability of approximately 800 msec allows a spacecraft to be deployed onto interplanetary trajectories from a standard Geostationary Transfer Orbit (GTO). This capability could enable nanosat constellations for interplanetary missions.

Only a few specialized launch vehicles have upper stages with the ability for in-space restarts; these are typically reserved for expensive government-owned reconnaissance, communications, or command & control satellites. For existing rideshare launch opportunities, nano-scale spacecraft are delivered to orbit as passive secondary payloads and must accept whatever orbit they achieve during the deployment process.

Secondary payloads, especially in the nanosat class, have no ability to modify their initial orbit and currently remain a novelty with little capability to accomplish serious scientific, strategic, or commercial missions.

### SUMMARY

There is a need for a propulsion system configured to ride along with the secondary payload during launch and able to reposition itself or maintain the orbit after deployment. Such a device would benefit the entire small satellite industry.

However, if this device were constructed using conventional high-explosive propellants, the “Ride-along” payloads each with their own propulsion system would dramatically increase the risks to the primary payload. Managing this risk will likely result in prohibitive launch costs. See Goldstein, E., The Greening of Satellite Propulsion, AEROSPACE AMERICA, 2012, pp. 26-28. Thus, a preferred embodiment of a “rideshare” propulsion unit should use a non-toxic propellant and feature inherently safe designs. Hybrid rocket motors have the potential to fulfill this low-risk fight requirement.

The Multiple Use Plug Hybrid (for) Nanosats (MUPHyN) prototype may fill this niche application for NanoSat and CubeSat scale spacecraft propulsion systems. This propulsive unit can be integrated onto a CubeSat payload and flown on rideshare missions with no risk increase to the primary payload.

Volumetric efficiency is a prime consideration for CubeSat systems, thus embodiments of the present disclosure provide compactness and simplicity as design elements for the MUPHyN systems. Because of volumetric constraints, conventional propulsion systems with high expansion ratio gimbaled nozzles and reaction control thrusters are infeasible in the CubeSat form factor. The CubeSat scale is simply too small to allow the complex mechanical subsystems to be integrated while still leaving room for the payload and supporting avionics.

Embodiments of the MUPHyN thruster offer several features that are uniquely suited for nanosat, and particularly CubeSat, applications. These features may include (1) a highly compact truncated aerospike nozzle, (2) non-mechanical thrust vectoring using secondary fluid injection on the aerospike nozzle, (3) a hybrid fuel grain with an embedded helical port, or (4) a non-pyrotechnic ignition system. This synthesis of technologies is unique to the MYPHyN thruster design and no other commercial or government entity has produced comparable work that has been published in open literature. Embodiments of the resulting system may be compact, non-toxic, non-explosive, and uses non-pyrotechnic means for reliable motor ignition. The system offers the simplicity of a mono-propellant thruster but provides significantly higher specific impulse performance.

FIGS. 1b and 1b presents a 6-U CubeSat design proposed for the NASA Edison flight demonstration program that features the MUPHyN thruster as its primary propulsion system. FIG. 1a shows the external view of the spacecraft. FIG. 1b shows the internal layout of the MUPHyN sub-system components including the liquid propellant tanks and the gaseous oxygen (GOX) tanks used to supply a top-pressure to the propellant delivery systems. Supporting avionics and auxiliary attitude control subsystems are also shown.

### BRIEF DESCRIPTION OF THE DRAWINGS

FIG. 1a illustrates an embodiment of a prophetic 6-U CubeSat.

FIG. 1b illustrates an embodiment of the internal component layout of a prophetic 6-U CubeSat.

FIG. 2 illustrates a Surrey Satellite Technology “pancake” hybrid rocket motor.

FIG. 3 illustrates a Pennsylvania State University “vortex injection” hybrid motor.

FIG. 4a illustrates an exploded view of a prototype electrical-discharge solid-fuel ignition system.

FIG. 4b illustrates a prototype electrical-discharge solid-fuel ignition system being fired.

FIG. 5 illustrates an embodiment of an exploded view of a prototype MUPHyN thruster assembly.

FIG. 6 illustrates an embodiment of a MUPHyN coolant flow path.

FIG. 7 illustrates an embodiment of some aerospike nozzle coolant flow channels on the bottom of an example aerospike nozzle.

FIG. 8 illustrates the heat transfer coefficient and heat transfer rate for an example aerospike surface.

FIG. 9 illustrates a coolant side heat transfer coefficient and average coolant quality for a range of coolant pressures.

FIG. 10 illustrates the predicted nozzle surface temperatures together with the nitrous oxide temperatures.

FIG. 11 illustrates the mass fluxes predicted by the SPI model, the HEM, the NHNE model, and the CNHNE model for nitrous oxide with various downstream pressures and an upstream pressure of 5.58 MPa and temperature of 295 K.

FIG. 12 illustrates the nitrous oxide coolant flow and states according to embodiments of the present disclosure.

FIG. 13 illustrates the mass flow rate variation with heat transfer into oxidizer flow for single and double pressure drop embodiments.

FIG. 14 illustrates a Plumbing and Instrumentation Diagram (P&ID) for a Mobile Nitrous oxide Supply and Test Resource (MoNSTeR) cart.

FIG. 15 illustrates an example MUPHyN assembly mounted in a four degree-of-freedom thrust stand.

FIG. 16 illustrates the typical thrust and chamber pressure traces (test results) for example MUPHyN hot fires.

FIG. 17 illustrates multiple example fuel grains after test firings.

FIG. 18 illustrates the aerospike nozzle temperature for both ABS and graphite insulated center plug according to embodiments of the present disclosure.

FIG. 19 illustrates an isometric view of example fuel grain geometries according to embodiments of the present disclosure.

FIG. 20 illustrates a plan view of an example fuel grain geometry in a pre-combustion chamber according to embodiments of the present disclosure.

FIG. 21 illustrates plumes for example MUPHyN designs according to embodiments of the present disclosure.

FIG. 22 illustrates an example MUPHyN motor plume with and without active secondary injection according to embodiments of the present disclosure.

FIG. 23 illustrates the secondary flow side force, mass flow rate, and Isp with nitrogen secondary injection for embodiments of the present disclosure.

FIG. 24 illustrates the secondary flow side force, mass flow rate, and Isp with helium secondary injection for embodiments of the present disclosure.

FIG. 25 illustrates the secondary flow side force, mass flow rate, and Isp with oxygen secondary injection for embodiments of the present disclosure.

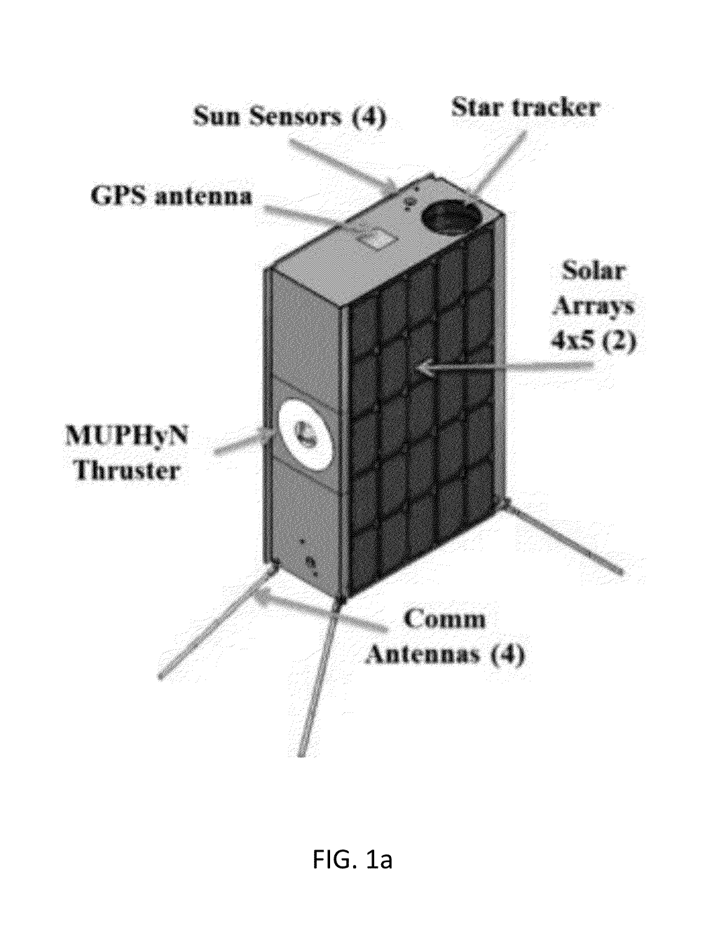

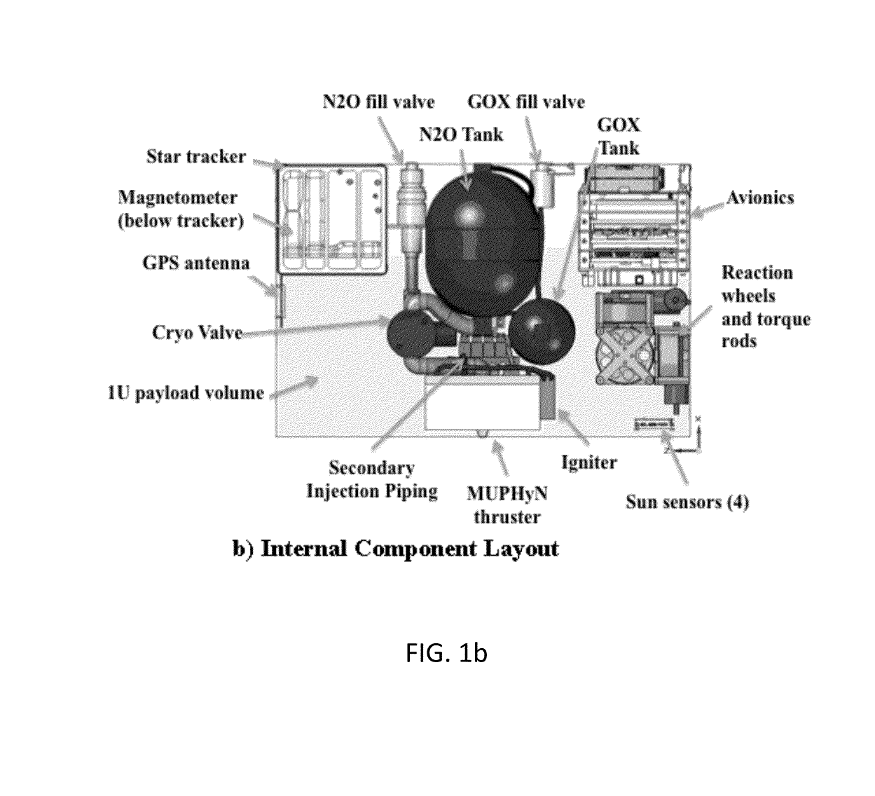

### DETAILED DESCRIPTION

The present disclosure covers apparatuses and associated methods for hybrid rocket motors. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional”, “optionally”, or “or” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The following examples are illustrative only and are not intended to limit the disclosure in any way.

### EXAMPLES

### I. MUPHyN Design

A. Leveraging the Aerospike Nozzle for the MUPHyN Design

While the aerospike nozzle has well known altitude compensation capability during endo-atmospheric fight, it also presents significant advantages for exo-atmospheric applications. Because of its unique shape, the aerospike nozzle can be constructed with a higher area expansion ratio and more compact form factor than a conventional bell nozzle of the same mass. The higher expansion ratio provides better performance in a space environment; the compact form factor offers significant improvement in volumetric efficiency. Most importantly, the aerospike nozzle can be thrust vectored fluid-dynamically by injecting propellant asymmetrically near the nozzle base.

The MUPHyN configuration exploits advantages of the aerospike nozzle to develop a very compact system that employs secondary injection on a truncated annular aerospike nozzle for thrust vectoring. A secondary fluid may be injected near the end of the aerospike nozzle to deflect the plume. Fluid-mechanical interactions with the primary flow field create a high-pressure region upstream of the secondary injection port. This interaction amplifies the side force created by the secondary injection. Cold gas tests have shown that this amplification factor approaches 140% compared to reaction-control alone.

Additionally, because of the unconstrained nozzle boundary, orifices used for secondary injection can be used for reaction control without the primary thruster operational. When this vectoring potential is harnessed and incorporated into a controlled thrust-vectoring scheme, the nozzle may be configured for six degrees-of-freedom (6-DOF) attitude and velocity control without mechanical nozzle gimbals or additional reaction control thrusters.

B. Applications of Digital Manufacturing

Advancements in digital manufacturing (often referred to as rapid prototyping) have revolutionized a variety of industries in recent years, and offer a similar potential for hybrid rocket motor design and manufacture. In particular, complex or difficult-to-cast grain geometries, especially on a small scale, are well suited to rapid prototyping techniques.

Some of the authors of the present disclosure recently demonstrated viability of thermoplastic as a hybrid rocket fuel grain material. This research demonstrated that, when coupled with N₂O as the oxidizer, Acrylonitrilebutadiene-styrene (ABS) burns with a specific impulse (Isp) that is nearly equivalent to the traditional hybrid rocket fuel hydroxyl-terminated polybutadiene (HTPB). ABS and HTPB fuel regression rates were measured to be nearly identical.

Unlike HTPB, which is a thermo-setting material, ABS is a thermoplastic that melts before vaporizing when subjected to heat. This property makes ABS one of the materials of choice for fused deposition modeling (FDM) rapid prototyping machines. Because ABS can be formed into a wide variety of shapes using modern additive manufacturing and rapid prototyping techniques, it is possible to embed complex high-surface area flow paths within the fuel grain. These internal flow paths allow for motor aspect ratios that are significantly shorter than can be achieved using conventional solid, hybrid, or mono-propellant technologies. These flow paths cannot be achieved with thermo-setting materials that are cast using tooling that must be removed once the material is set. The similarity in burn performance of ABS to HTPB allows FDM to manufacturing of fuel grains with little or no performance penalty.

C. Design and Development of the Helical MUPHYN Fuel Grain

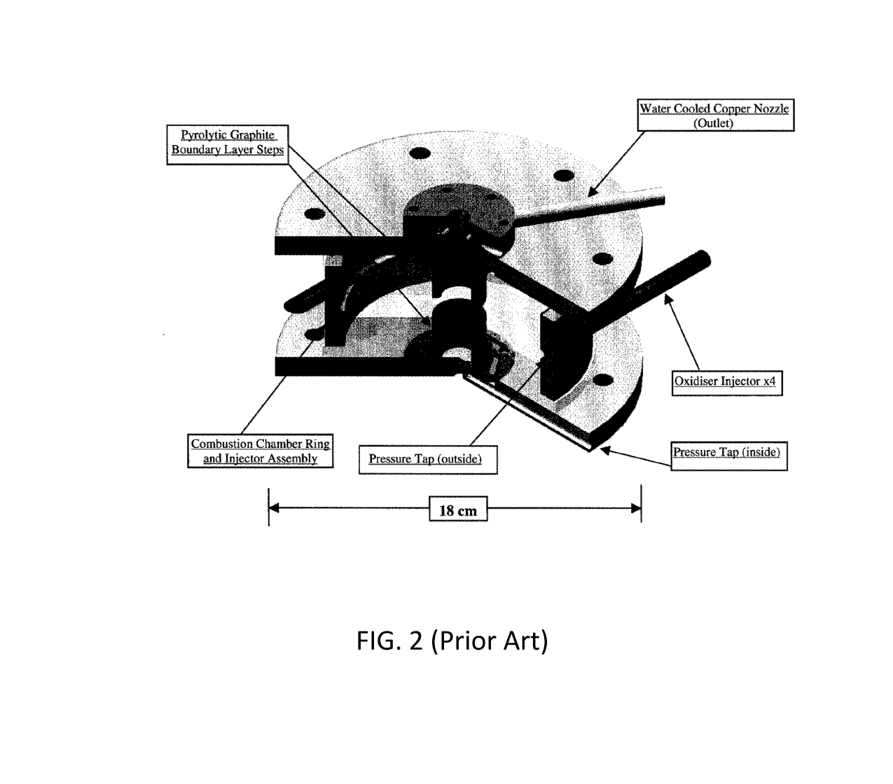

Surrey Satellite Technology, LTD, (“SST”) has previously developed a compact hybrid motor concept, a “pancake” hybrid, in 2001. See Gibbon, D. and Haag, G. S., Investigation of an Alternative Geometry Hybrid Rocket for Small Spacecraft Orbit Transfer, TECH. REP., SURREY SATELLITE TECHNOLOGY LTD, 2001.) FIG. 2 shows the pancake design with tangential injection on the exterior of the short motor casing. SST demonstrated relatively high combustion efficiencies compared to standard hybrid motor designs, a feature they attributed to centrifugal forces keeping unburned pieces of fuel away from the nozzle exit in the center of the motor.

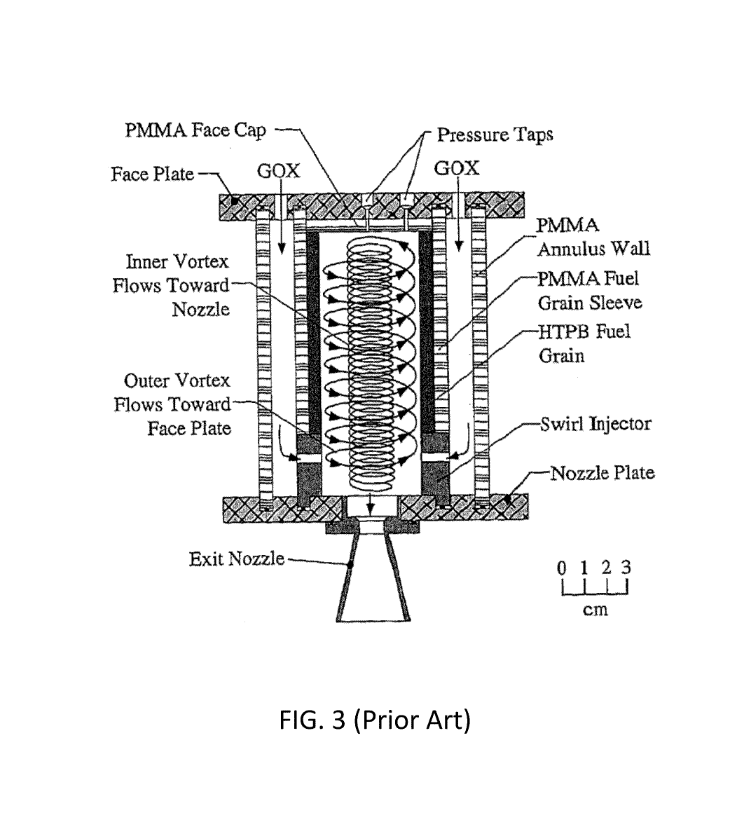

Orbital Technologies Corporation (OrbiTech) designed a “vortex hybrid” motor. See Knuth, W. H., Chiaverini, M. J., Sauer, J. A., and Gramer, D. J., Solid-Fuel Regression Rate Behavior of Vortex Hybrid Rocket Engines, THE JOURNAL OF PROPULSION AND POWER, Vol. 18, 2002, pp. 600-609.) The OrbiTech design uses tangential injection that is balanced such that co-axial vortexes form in the motor port. FIG. 3 shows the motor design featuring the vortex flow path. These coaxial vortices increase the effective oxidizer mass flux near the fuel surface increasing regression and the center vortex provides ample time for mixing and combustion. This design showed high regression rates with traditional rubber fuels as well as high combustion efficiencies similar to the “pancake” design.

Unlike the “pancake” hybrid in form factor, the MUPHyN design moves the injectors from the outside of the case to the inside allowing for the easy incorporation of an aerospike nozzle in the center of the motor and the incorporation of regenerative cooling for the inner side of the aerospike throat. This design feature allows for the potential marriage of a form factor applicable to small satellites as well as the combustion efficiency gains of vortex and pancake hybrids with the volumetric and performance benefits of aerospike nozzles.

For the MUPHyN Motor, the ability to manufacture complex grain designs is an enabling technology. The MUPHyN thruster takes advantage of these manufacturing techniques by embedding a helical fuel port inside of the fuel grain. This helical port structure is enabled using FDM to fabricate the ABS fuel grain module with the embedded helical port. This embedded helical port provides an extended length flow path with a large surface contact area in a short form factor. The centrifugal forces created by the combustion gases rotating in the helix core significantly increase the fuel regression rates and propellant mass flow. The helical core design feature produces sufficient total fuel mass flow so that the total oxidizer-to-fuel ratio remains low enough to prevent nozzle erosion during the entire motor burn.

D. Non-Pyrotechnic, Multiple Use, Inductive-Discharge Igniter for MUPHyN Thruster

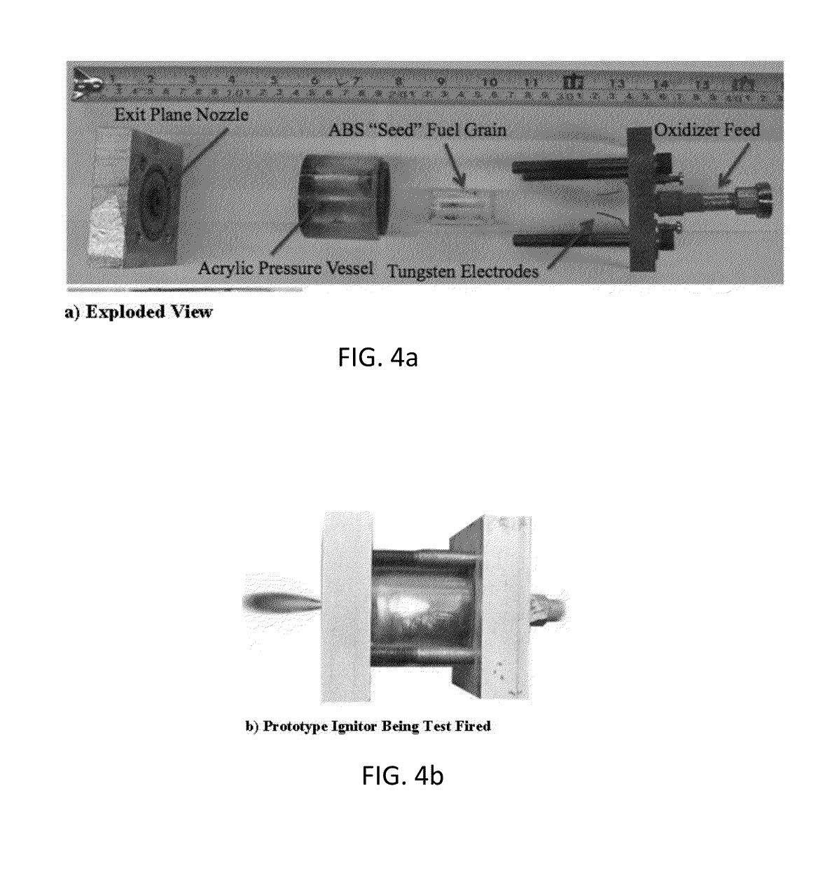

A parallel development activity at Utah State University has produced a prototype gas-generation ignition system that uses a low-energy, high-voltage inductive spark to ignite a hydrocarbon-based fuel like ABS or HTPB in gaseous oxygen. The gas-generation system allows for multiple restarts with a single hydrocarbon fuel grain, and is effectively a small hybrid rocket motor. The design alleviates safety issues associated with bi-propellant ignition sources and circumvents the disadvantages of single-use small solid propellant igniters. FIG. 4a shows an exploded view of the prototype igniter design. FIG. 4b shows the solid-fuel igniter being pulsed. The prototype igniter is constructed with an acrylic pressure case so that the electrical discharges can be seen externally. The number of restarts possible with this igniter is only limited by the amount of solid fuel in the igniter. To date, tests have been conducted showing up to 27 ignitions of the prototype igniter on the same fuel grain. Reliable ignition requires less than 240 Watts, with a total energy consumption of less than 5 Joules.

### II. Prototype MUPHyN Thruster

A. MUPHyN Components

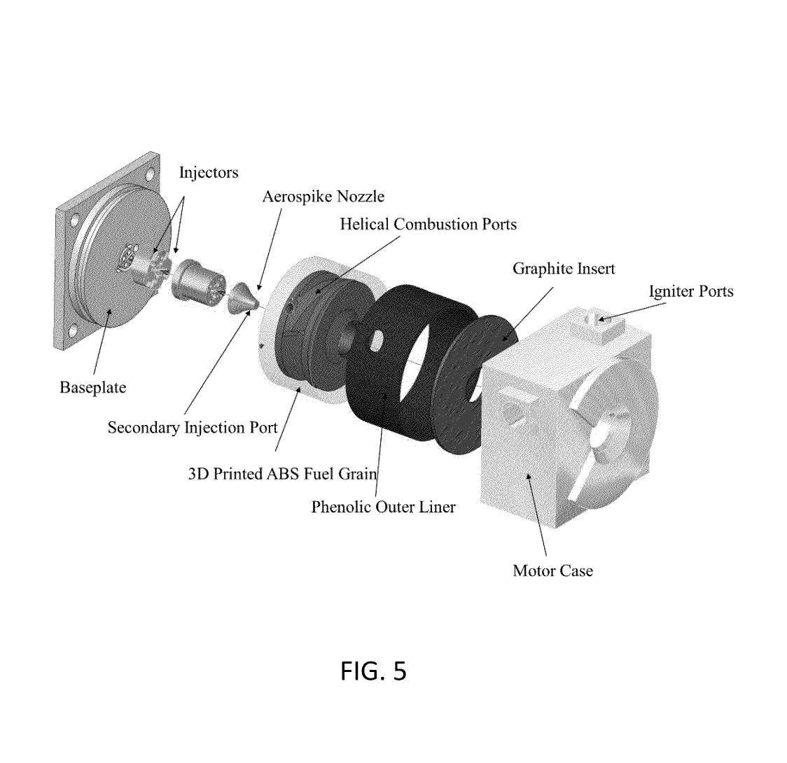

FIG. 5 shows an exploded view of the prototype MUPHyN thruster assembly and summarizes the primary design parameters. This prototype article was used to perform the ground tests to be described in the following sections of this disclosure. This prototype MUPHyN thruster design includes an FDM-manufactured fuel grain with an embedded helical fuel port, and an annular aerospike nozzle held by a central injector support fixture. The motor case is designed to fit within a 1U section of the CubeSat bus.

The aerospike nozzle contour was designed using the method of characteristics technique developed by Lee and Thompson. See Lee, C. and Thompson, D., Fortran Program for Plug Nozzle Design; Technical Memorandum X-53019, TECH. REP., NASA MARSHALL, 1964. The design nozzle expansion ratio is 2.25:1 and was selected as a compromise between performance, manufacturability, and heat transfer considerations that will be discussed in detail in the sections to follow in this disclosure. The 2.25:1 expansion ratio results in a nozzle that is slightly over expanded for the ambient pressure conditions at the test location in Logan, Utah, approximately 1300 meters above mean sea level (MSL). The nozzle was truncated at 70% of its theoretical length.

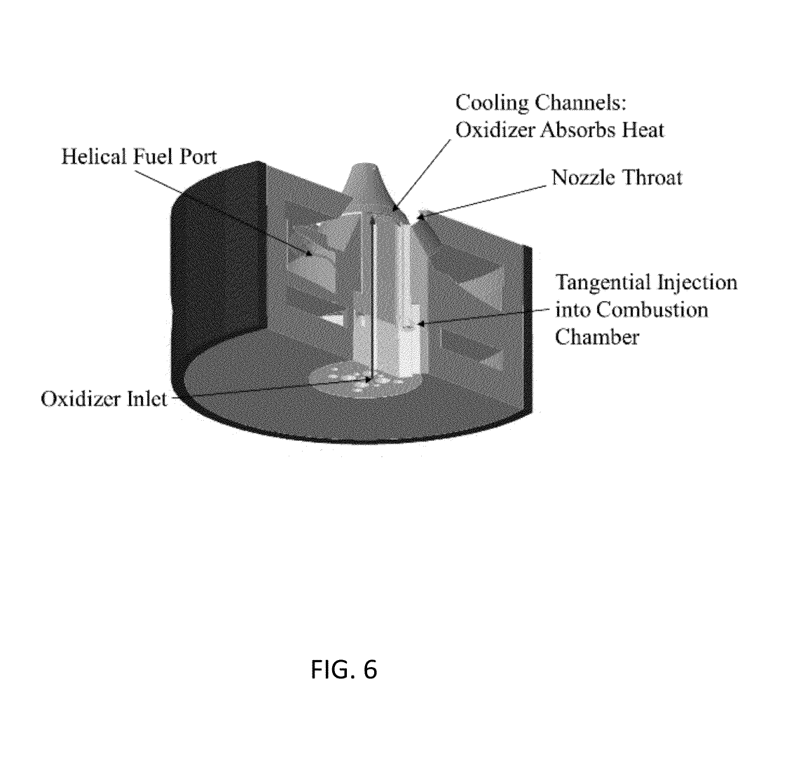

For some embodiments, the inner throat and nozzle plug are regeneratively cooled and the outer throat is constructed from ablative high-density graphite. Nitrous oxide (the oxidizer) flows through the base of the MUPHyN, to the throat, and then down and out the tangential injectors into the combustion chamber. FIG. 6 shows the oxidizer/coolant flow path. The walls of the combustion chamber are insulated with a phenolic liner on the sides and a graphite insert on the top (downstream near the nozzle exit). In one embodiment, the outer casing of the test article is manufactured out of medium carbon steel. The base of the motor case is aluminum and the aerospike components are copper to support heat transfer to the oxidizer. The prototype test article included a single secondary injection port to allow the effectiveness of secondary injection thrust vectoring to be evaluated for hot-fire test conditions.

Table 1 lists several design parameters for one embodiment of the present disclosure.

TABLE 1
MUPHyN Motor Design Parameters

| Parameter | Value |
|---|---|
| Design Thrust | 200N |
| Chamber Pressure | 690 kPa |
| Expansion Ratio | 2.25 |
| Throat Area | 2.01 sq. cm |
| Oxidizer | Nitrous Oxide |
| Fuel | Acrylonitrile Butadiene Styrene |
| Design Specific Impulse | 200 s |
| Design Thrust Vectoring Side Force | 10N |
| Secondary Fluid | Helium, Nitrogen, or Oxygen |

B. Regenerative Cooling System Design Features

A recurring problem with aerospike nozzle designs is managing the high thermal load imparted to the nozzle by the combustion products around the small annular throat exit gap. Aerospike nozzles with high expansion ratios have a far larger throat surface area than a bell or conical nozzle with the same throat exit area and imparted heat loads are significantly higher. Fortunately, the compact design of the MUPyN thruster allows for relatively straight-forward application of regenerative cooling using the oxidizer flow.

Lemieux et al. at California Polytechnic State University has demonstrated nitrous oxide being used to cool a copper throated conical nozzle and to cool an aerospike nozzle in a traditionally long-form hybrid motor. See Lemieux, P., Nitrous Oxide Cooling in Hybrid Rocket Nozzles, PROGRESS IN AEROSPACE SCIENCES, Vol. 46, 2010, pp. 106; Lemieux, P., Development of a Reusable Aerospike Nozzle for Hybrid Rocket Motors, 39TH AIAA FLUID DYNAMICS CONFERENCE, 2009; Lemieux, P., et al., Design and Analysis of a Reusable N2O-Cooled Aerospike Nozzle for Labscale Hybrid Rocket Motor Testing, 47TH AIAA/ASME/SAE/ASEE JOINT PROPULSION CONFERENCE & EXHIBIT, 2011. The authors discovered that saturated nitrous oxide, when care is taken not to allow the liquid phase to fully boil off, is an effective regenerative coolant. If the liquid phase is allowed to fully boil of, heat transfer to the coolant reduces significantly. If heat transfer is high enough, the resulting vapor could reach temperatures that would support exothermic decomposition, an event that could produce catastrophic failure of the aerospike nozzle.

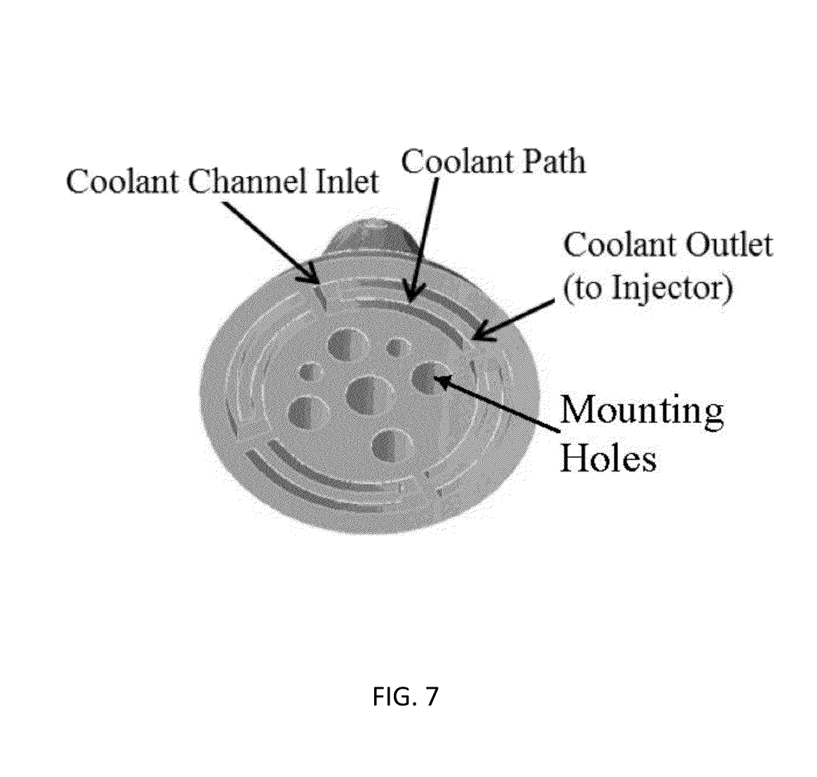

In one embodiment, the MUPHyN motor shape, with its compact longitudinal form factor, allows oxidizer to be passed through coolant channels near the throat and then down back down to an injector near the bottom of the combustion chamber with no external plumbing. FIG. 7 shows the cooling channels on the MUPHyN nozzle.

C. Analysis of the Convective Heat Transfer from the Combustion Flame Zone to the Aerospike Nozzle

Convective heat transfer from the nozzle flow field to the nozzle surface in traditional deLaval rocket nozzles is generally predicted with correlations derived for fully developed pipe flow. Convective heat transfer in an aerospike nozzle is non-fully developed and the axisymmetric model developed by Mayer for external expansion, spike, and other novel rocket nozzle configurations is more applicable. Mayer, E., Analysis of Convective Heat Transfer in Rocket Nozzles,” ARS JOURNAL, 1961, pp. 911-916. Instead of a hydraulic diameter based correlation, the model created by Mayer uses a thermal Reynolds number of the form

$${Re}_{Γ} = \frac{{ρ}_{∞} {U}_{∞} Γ}{{μ}_{∞}} \qquad ( 1 )$$

where Γ is the thermal boundary layer thickness. Assuming a control volume inside this thermal boundary layer, an energy balance yields

$${q}_{w} = {μ}_{∞} {\overline{c}}_{p} {T}_{0 , ∞} \frac{d}{d s} {Re}_{Γ} \qquad ( 2 )$$

A modified form of the Reynold's analogy correlation,

$${St}_{∞} = B {{Pr}^{- \frac{2}{3}}}_{∞} {Re}_{x , ∞}^{- b} \qquad ( 3 )$$

is applied to relate the thermal Reynolds number to the traditional fluid-dynamic Reynolds number,

$${Re}_{x , ∞} = {\int }_{0}^{s} \frac{{ρ}_{∞} {U}_{∞}}{{μ}_{∞}} d s \qquad ( 4 )$$

In Eqs. (3) and (4), St_{∞} is the Stanton number, B and b are empirical constants, and Pr is the Prandtl number of the core oxidizer flow. The heat transfer coefficient h, is expressed in terms of the integral,

$${h}_{2} ( s ) = {ρ}_{∞} {\overline{c}}_{p} {U}_{∞} St = \frac{{β}^{\frac{1}{( 1 - b )}} {BPr}^{- \frac{2}{3}} {ρ}_{∞} {\overline{c}}_{p} {U}_{∞}}{{[ {\int }_{0}^{s} {β}^{\frac{1}{( 1 - b )}} {ρ}_{∞} {\overline{c}}_{p} {U}_{∞} {μ}_{∞}^{- 1} ]}^{b}} \qquad ( 5 )$$

where the parameters in Eq. (5) are defined as:

$$β = {( \frac{{T}_{surf}}{{T}_{*}} )}^{( 1 - b ( 1 + ω ) )} \\ B = 0.0296 \\ b = \frac{1}{5} \\ ω = \frac{3}{2} \qquad ( 6 )$$

Equation (5) is corrected for annular surfaces to yield the relationship:

$${h}_{3} ( s ) = {{h}_{2} ( s ) [ \frac{{r}^{\frac{1}{1 - b}} {\int }_{0}^{8} {β}^{\frac{1}{( 1 - b )}} {ρ}_{∞} {\overline{c}}_{p} {U}_{∞} {μ}_{∞}^{- 1} }{{\int }_{0}^{8} {( βr )}^{\frac{1}{( 1 - b )}} {ρ}_{∞} {\overline{c}}_{p} {U}_{∞} {μ}_{∞}^{- 1}} ]}^{b} \qquad ( 7 )$$

Table 2 lists combustion and nozzle parameters used to calculate fluid properties for this model. The combustion products were computed with the NASA code Chemical Equilibrium Analysis with Applications. See Gordon, S. and McBride, B. J., Computer Program for Calculation of Complex Chemical Equilibrium Compositions and Applications I. Analysis, TECH. REP., NASA RP-1311, 1994; McBride, B. J. and Gordon, S., Computer Program for Calculation of Complex Chemical Equilibrium Compositions and Applications II, Users Manual and Program Description, TECH. REP., NASA RP-1311, 1996.)

For this analysis, a uniform aerospike surface temperature of 400 K was assumed. Although the actual surface temperature will be variable, this surface variation should be small compared to the difference between the surface temperature and the far higher combustion gas flame temperature. The local mean cross section combustion gas temperature (T(s)), pressure (P(s)), and sonic velocity (U(s)) were calculated using local isentropic flow relationships,

$$T ( s ) = \frac{{T}_{0}}{( 1 + \frac{1}{2} ( γ - 1 ) {M ( s )}^{2} )} \\ P ( s ) = \frac{{P}_{0}}{{( 1 + \frac{1}{2} ( γ - 1 ) {M ( s )}^{2} )}^{\frac{γ}{( γ - 1 )}}} \\ U ( s ) = M ( s ) \sqrt{γ {R}_{g} T ( s )} \qquad ( 8 )$$

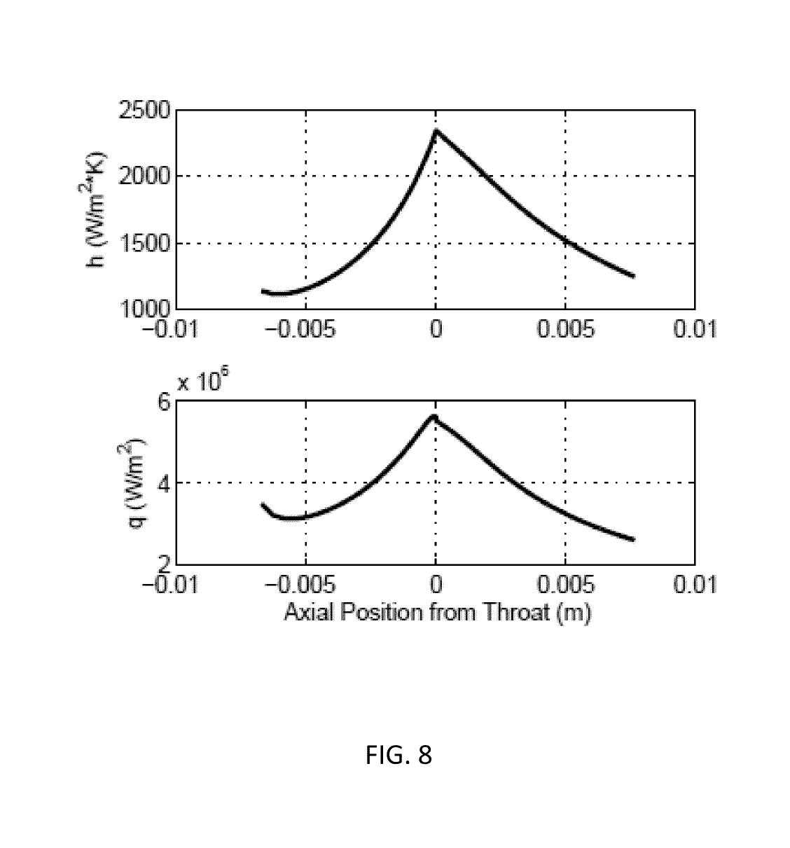

The convective heat transfer to the nozzle was calculated by breaking the surface into a series of local nodes. A 0.75 cm convergent section was chosen to model boundary layer growth before the throat. Cosine clustering towards the throat was used to place nodes along the convergent section and the nodes created by a method of characteristics solver were used for the divergent section. Conical frustum areas between nodes and trapezoidal integration were used for surface integration of total heat transfer rates. Because of the significantly lower surface heating rates, the base region was not included in this analysis. FIG. 8 plots the resulting convective heat transfer coefficients and area specific heat transfer rates. The resultant total heat transfer computed via this method is about 3500 Watts.

As noted previously, the low expansion ratio of 2.25:1 on the prototype MUPHyN was significantly lower than would be desirable for a space thruster. Assuming a fixed throat area (and exit mass flow), for an aerospike nozzle the exposed surface area increases proportionately with nozzle expansion ratio. A high expansion ratio nozzle will experience a significantly higher convective heating load than will a low expansion ration nozzle. Thus, the low expansion ratio of the MUPHyN prototype was selected to allow a significant heating margin of safety for the preliminary rounds of testing. Once the precise convective heating levels are better understood, future MUPHyN development tests will scale the expansion ratio upwards to be more efficient for vacuum operation.

TABLE 2
MUPHyN Motor Combustion and Nozzle Parameters

| Parameter | Value | |
|---|---|---|
| Outer Throat Radius | 1.2 | cm |
| Chamber Pressure | 775.6 | kPa |
| Specific Heat Ratio | 1.27 | |
| Molecular Weight | 24.247 | |
| Expansion Ratio | 2.25 | |
| Viscosity Temperature Exponent | 1.5 | |
| Convergent Surface Length | 0.75 | cm |
| Aerospike Surface Temperature | 400 | K |

D. Analysis of the Regenerative Cooling Nitrous Oxide Heat Transfer Rate

The coolant side heat transfer can be modeled with relations originally developed for boiling in smooth circular tubes. KANDLIKAR, S. G. AND NARIAI, H., HANDBOOK OF PHASE CHANGE: BOILING AND CONDENSATION, TAYLOR AND FRANCIS, 1999; INCROPERA, F. P., DEWITT, D. P., BERGMAN, T. L., AND LAVINE, A. S., FUNDAMENTALS OF HEAT AND MASS TRANSFER (6^{th} Ed., John Wiley and Sons 2007). Although, as can be clearly seen in FIG. 7, the coolant channels in the MUPHyN are not circular tubes, the flow in the impinging jet channels with fins should facilitate even higher heat transfer. Thus, it is believed that this will yield a conservative estimate.

Nitrous oxide is expanded through an orifice before reaching the cooling channels. This expansion drops the fluid pressure below the initial saturation pressure. This results in multiphase heat transfer. Because the phase change removes significantly more heat than convection to liquid flow alone, the multiphase heat transfer is expressed in terms of a ratio relative to liquid heat transfer alone. Generally, the larger of the two values in Eq. (9) will be used.

$$\frac{h}{{h}_{1}} = 0.6683 {( \frac{{ρ}_{l}}{{ρ}_{v}} )}^{0.1} {{X}^{0.16} ( 1 - X )}^{0.64} f ( Fr ) + 1058 {( \frac{{q}^{″}}{\dot{m} {h}_{fg}} )}^{0.7} {( 1 - X )}^{0.8} {G}_{s , f} \\ \frac{h}{{h}_{1}} = 1.136 {( \frac{{ρ}_{l}}{{ρ}_{v}} )}^{0.45} {{X}^{0. .72} ( 1 - X )}^{0.08} f ( Fr ) + 667.2 {( \frac{{q}^{″}}{\dot{m} {h}_{fg}} )}^{0.7} {( 1 - X )}^{0.8} {G}_{s , f} \qquad ( 9 )$$

In Eq. (9), the term G is a constant related to the specific materials and coolants used, but generally ranges around 1.0. The stratification parameter, f (Fr), was assumed to be unity also, as it is doubtful that the coolant will have time to experience buoyancy effects over the extremely short coolant channel length. Table 3 lists the other relevant parameters used in this calculation. For this analysis, the total heat transfer rate was rounded up from the hot gas side heat transfer calculated above. Fluid specific properties were computed using Helmholtz relations for real fluids. See Span, R. and Wagner, W., Equations of State for Technical Applications. I. Simultaneously Optimized Functional Forms for Nonpolar and Polar Fluids, INTERNATIONAL JOURNAL OF THERMOPHYSICS, Vol. 24, No. 1, 2003, pp. 1-39; Span, R. and Wagner, W., Equations of State for Technical Applications. II. Results for Nonpolar Fluids, INTERNATIONAL JOURNAL OF THERMOPHYSICS, Vol. 24, No. 1, 2003, pp. 41-109; Span, R. and Wagner, W., Equations of State for Technical Applications. III. Results for Polar Fluids, INTERNATIONAL JOURNAL OF THERMOPHYSICS, Vol. 24, No. 1, 2003, pp. 111-162.

State properties for nitrous oxide at different coolant pressures were calculated assuming Isenthalpic expansion across the orifice before the coolant channels. Any heat transfer to the fluid was assumed to happen after this initial expansion. Depending on coolant pressure, the ratio of multiphase-heat transfer to liquid-only heat transfer ranges between 10 and 20 for this configuration.

To complete the heat transfer model, a liquid phase heat transfer relationship is required. The liquid heat transfer coefficient is modeled by Sutten et al. and Incropera et al. See SUTTON, G. P. AND BIBLARZ, O., ROCKET PROPULSION ELEMENTS SEVENTH EDITION (Wiley 2001); INCROPERA, F. P., ET AL., FUNDAMENTALS OF HEAT AND MASS TRANSFER (John Wiley and Sons 6^{th} Ed. 2007).

$${h}_{1} = 0.023 {c}_{{ρ}_{l}} \frac{\dot{m}}{A} {( \frac{DVU {ρ}_{l}}{{μ}_{l}} )}^{- 0.2} {( \frac{{μ}_{l} {C}_{{P}_{l}}}{{κ}_{l}} )}^{- \frac{2}{3}} \qquad ( 10 )$$

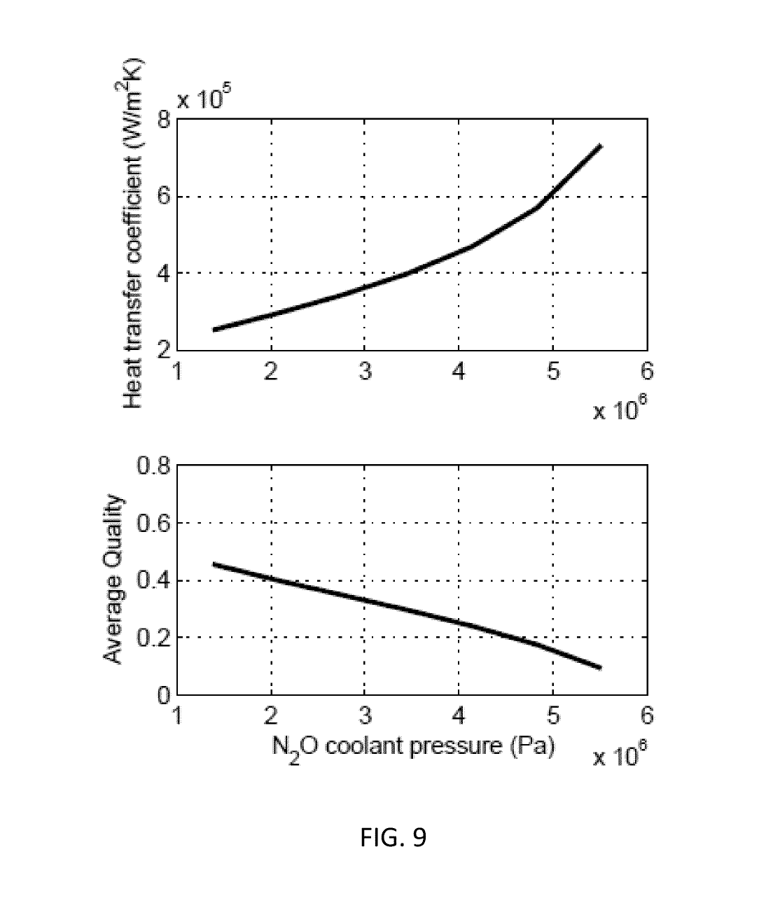

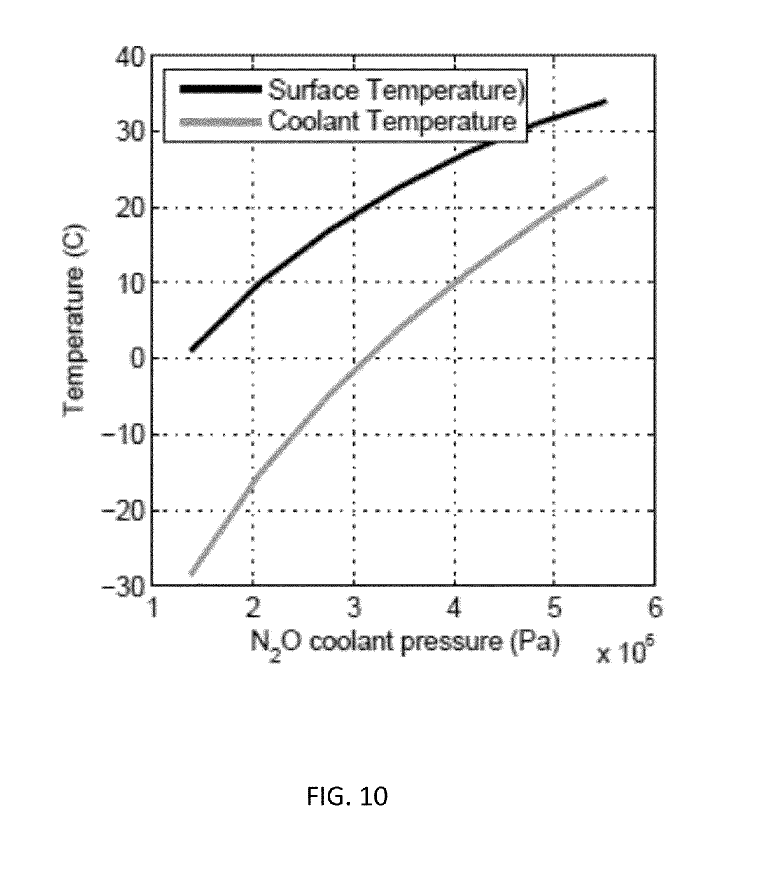

FIG. 9 plots the heat transfer coefficients computed using this method for a range of coolant pressures along with the average fluid quality. FIG. 10 plots the predicted nozzle surface temperatures along with the nitrous oxide temperatures.

TABLE 3
Boiling Heat Transfer Parameters

| Parameter | Value | |
|---|---|---|
| Specific heat transfer rate, q″ | 7430 | kW/sq meter |
| Total heat transfer rate | 3500 | W |
| Mass flow rate | 0.08 | kg/s (total) |

E. Non-Homogeneous, Non Equilibrium Two Phase Mass Flow Model

A modified version of the non-homogeneous non-equilibrium (NHNE) model developed by Dyer, et al. at Stanford University was used for injector size calculation. Dyer, J., Doran, E., Dunn, Z., Lohner, K., Zilliac, G., and Cantwell, B., Modeling Feed System Flow Physics for Self Pressurizing Propellants, AIAA 2007-5702, 2007. This model uses a weighted average of the homogeneous equilibrium (HEM) mass flux,

$${G}_{HEM} = \frac{\dot{m}}{A} = {ρ}_{2} \sqrt{2 ( {h}_{1} - {h}_{2} )} \qquad ( 11 )$$

and the incompressible mass flux (SPI),

$${G}_{SPI} = \frac{\dot{m}}{A} = \sqrt{2 {ρ}_{1} ( P - {P}_{2} )} \qquad ( 12 )$$

to compute a single mass flux using a weighted “non equilibrium parameter” k,

$$k = \frac{{T}_{b}}{{T}_{r}} = \sqrt{\frac{{P}_{1} - {P}_{2}}{{P}_{v} - {P}_{2}}} \qquad ( 13 )$$

The two-phase mass flux is calculated as a weighted average of the incompressible and HEM mass fluxes,

$${G}_{NHNE} = {C}_{d} ( \frac{1}{1 + k} {G}_{HEM} + ( 1 - \frac{1}{1 + k} ) {G}_{SPI} ) \qquad ( 14 )$$

In these relations the subscript 1 represents the conditions at the orifice inlet, and the subscript 2 represents the conditions at the outlet. This same relationship, with different pressure drops and initial qualities, applies to both the expansion orifice positioned before the coolant channels and the injector orifice that sprays into the combustion chamber.

The parameter k is the inverse square root of the Cavitation number and expresses the ratio of the difference between the upstream total pressure and the downstream pressure, and the vapor pressure and the downstream pressure. Small values for k demonstrate a high degree of cavitation in the flow and an increase in fluid quality in the injector orifice. When k is large, the incompressible SPI model is weighted heavily. When k is small, the two-phase HEM model is weighted heavily. The combined model of Eq. (14) allows for two-phase flow effects that plateau the mass flux as the downstream pressure is lowered. This is consistent with observed two-phase mass flow properties.

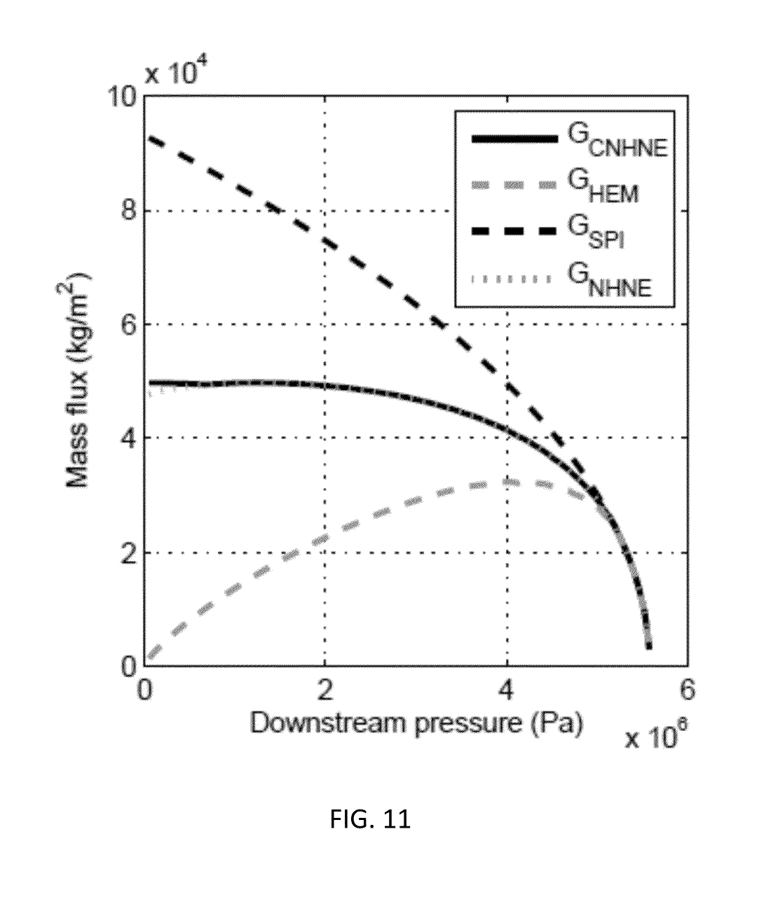

The model proposed by Dyer was further extrapolated to incorporate choking mass flow. For very small exit pressures, the mass fluxes predicted by the NHNE model decrease with decreasing exit pressure, a trend unlikely to exist in reality. Thus, a model was used that uses the maximum flow rate predicted by NHNE model for any downstream pressure between the upstream pressure and the exit pressure. FIG. 11 shows mass fluxes predicted by the SPI model, the HEM, the NHNE model, and the choked NHEM model (CNHNE) for nitrous that is slightly sub-cooled upstream of the injector. It is noteworthy that the SPI model and HEM are identical if the downstream fluid is still sub-cooled and the CHNHE and HNHE model are identical above about 1 MPa.

F. Injector and Expansion Orifice Size Calculation

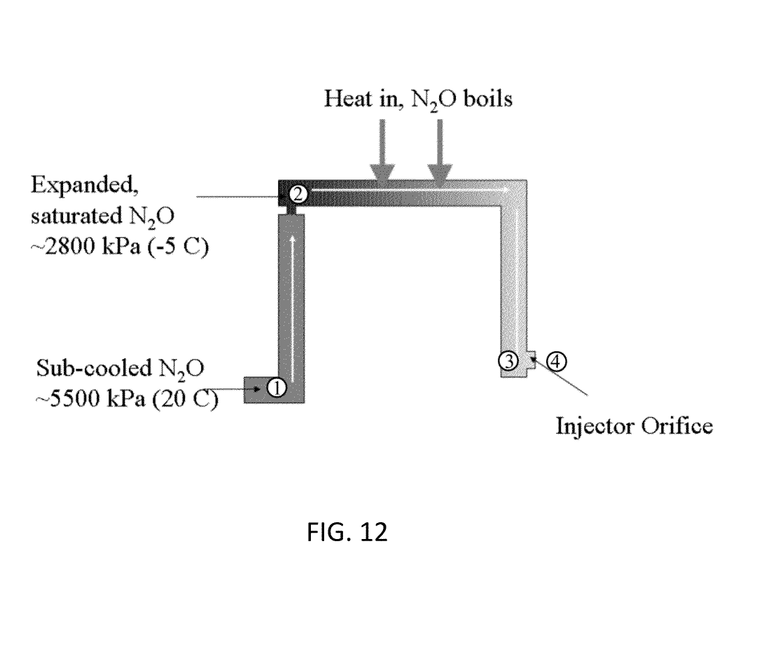

As shown in FIG. 12, the nitrous oxide flow through the cooling channels can be broken down into four fluid states. Nitrous oxide enters the MUPHyN motor regenerative cooling paths in liquid form at slightly above saturation pressure. As the fluid enters the cooling channels, it encounters a constrictive orifice that quasi-adiabatically expands the flow to a significantly lower pressure. Between states 2 and 3, external energy is added through heat transfer from the external combustor flow, and finally at the injector (state 4) the now multiphase fluid adiabatically expands to the combustor chamber pressure.

In order to maintain the desired coolant pressure and mass flow rates, the orifice before the coolant channels, as well as the injector orifice, must be correctly sized. Increasing the pressure drop across the initial orifice decreases the pressure and therefore the fluid temperature in the coolant channels. Also, reducing the coolant pressure increases the fluid vapor-to-liquid ratio (quality) of the fluid in the coolant channels. This increase in fluid quality significantly decreases the overall heat transfer coefficient. If this were the only parameter of interest it would therefore be desirable to maximize the heat transfer coefficient by minimizing the coolant quality. However, heat transfer into the fluid along the regenerative cooling channels can significantly influence the exit fluid state properties (including density), and will significantly affect the mass flow rate into the motor. Thus, it is desirable to have a large pressure drop before the coolant channels. The flow rate coupled to this initial pressure drop will not significantly vary with heat transfer into the coolant as will the flow rate across the injector orifice. Hence, this pressure drop has the effect of decoupling the total mass flow rate from the heat transfer into the fluid. If the fluid mass flow rate were significantly affected by the amount of regenerative heat transfer and the orifice sizes were designed for the steady state operational condition, a substantially higher mass flow rate would exist during the start up transient. This could result in a potential combustion chamber over pressurization during the start-up thermal transient for the motor.

It is desirable to pick orifice sizes between states 1 and 2, and also between states 3 and 4, such that the total mass flow rate is 0.08 kg/s and the pressure at state 2 and 3 is 2760 kPa (400 psi). Pertinent fluid parameters are listed in Table 4 based upon isenthalpic expansion described above and 3500 Watts of heat addition between states 2 and 3. An incompressible discharge coefficient of 0.85 was assumed for this analysis. This should be a reasonable number for square-edged orifices.

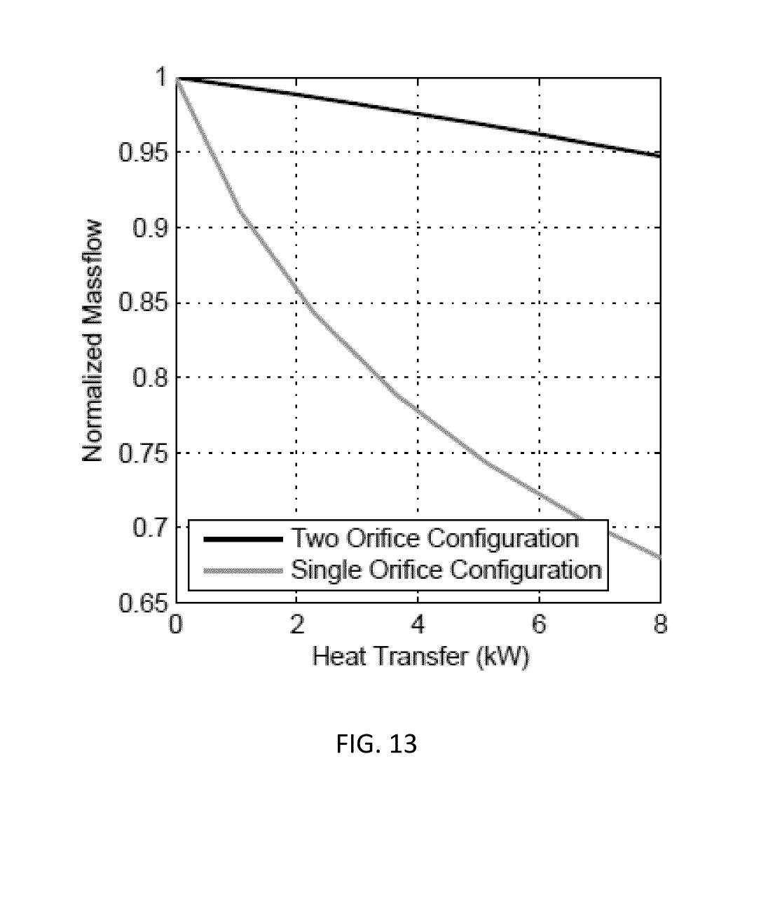

To achieve the design thrust level of 125 N for the prototype MUPHyN thruster, the injection and throttling orifices were sized to achieve a mass flow rate of approximately 80 g/s with a oxidizer inlet pressure is approximately 5500 kPa. The resulting the pressure is approximately 2750 kPa for each of the four coolant channels, and the design chamber pressure is approximately 690 kPa. Tables 4 and 5 show the corresponding fluid properties and coolant flux rates at each of the state-points 1-4. FIG. 13 illustrates the change in mass flow rate with heat transfer for this configuration and a configuration with heat transfer into the fluid before a single pressure drop into the combustion chamber. At the design operating condition of about 3500 Watts of heat transfer, the two orifice configuration described above will have a flow rate about 2% below that without heat transfer. If there was not a stabilizing initial pressure drop, the total mass flow rate would drop by nearly 21% once steady state heat transfer was reached.

TABLE 4
Nitrous Oxide Coolant States

| State | Fluid | Pressure | Quality | Total | Total | Total |
|---|---|---|---|---|---|---|
| 1 | 295K | 5590 kPa (810 | 0 | 770 kg/m\hat{ }3 | 218 kJ/Kg | 0.890 |
| 2 | 268K | 2760 kPa (400 | 0.26 | 232 kg/m\hat{ }3 | 218 kJ/Kg | 0.913 |
| 3 | 268K | 2760 kPa (400 | 0.44 | 153 kg/m\hat{ }3 | 262 kJ/Kg | 1.07 kJ/Kg- |
| 4 | 228K | 772 kPa (112 | 0.58 | 34.1 kg/m\hat{ }3 | 262 kJ/Kg | 1.18 kJ/Kg- |

TABLE 5
Nitrous Oxide Coolant States

| Ori- | | | | | Chosen |
|---|---|---|---|---|---|
| fice | G | G_{HEM} | G_{SPI} | Total Area | Orifice |
| 1-2 | 39,840 | 27,741 kg/m\hat{ }2−s | 66,035 | 2.008E−6 m\hat{ }2 | 0.8 mm |
| | | | | | (1/32 drill) |
| 3-4 | 14<460 | 8,739 kg/m\hat{ }2−s | 25,283 | 5.533E−6 m\hat{ }2 | 1.3 mm |
| | | | | | (#55 drill) |

### VI. Experimental Apparatus Used for MUPHyN Tests

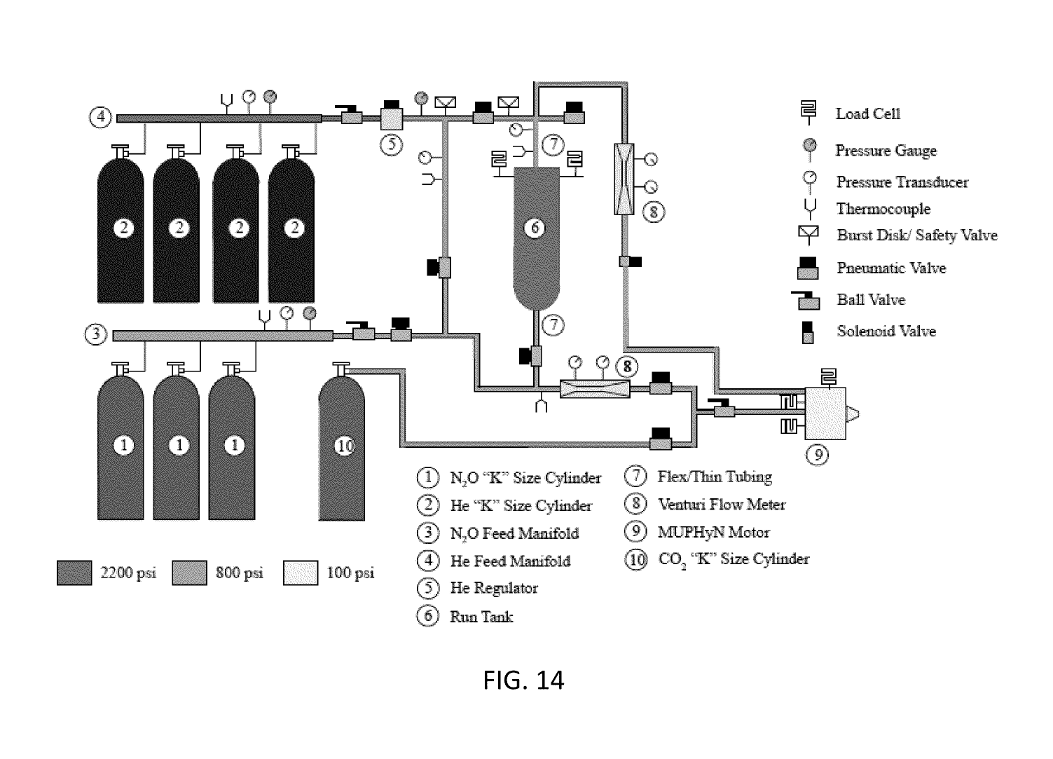

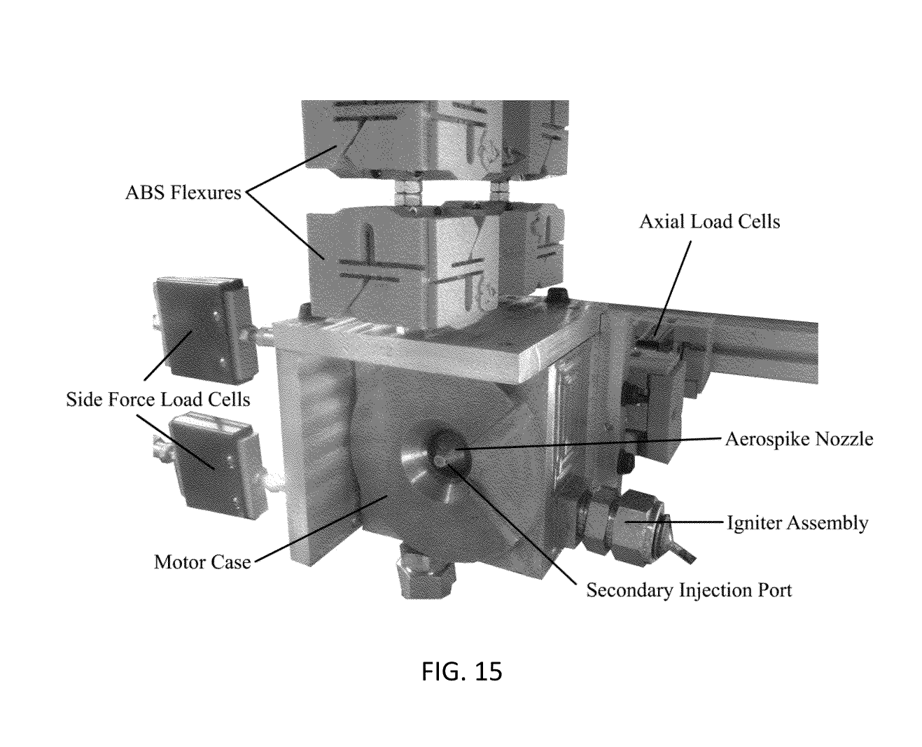

The MUPHyN hot-fire static tests used an existing test stand modified to accomplish the MUPHyN test objectives. This system features a Mobile Nitrous oxide Supply and Test Resource (MoNSTeR) cart that contains a run tank which is preloaded with nitrous oxide and then top pressured with helium for the duration of the burn. FIG. 14 shows the Piping and Instrumentation Diagram (P&ID) for the MoNSTeR cart oxidizer delivery system. Primary flow is controlled via a binary, pneumatic operated ball valve and secondary flow is controlled via a fast-response solenoid valve.

A custom designed Venturi flow meter measures primary oxidizer flow and another similar but smaller Venturi is used to measure the flow rate of the thrust vectoring fluid. For these measurements, the Venturi discharge coefficient was assumed equal to the high Reynolds number value of 0.985. The estimated flow accuracy for these meters is approximately 0.5 percent of the true flow rate.

To measure both axial thrust and side force, a four degree of freedom thrust balance was designed specifically for MUPHyN testing. Two axial load cells are used to measure axial thrust and a two side load cell measures the much smaller side forces as well as axial torque. The test stand features custom-engineered three axis flexures in the vertical and axial directions to limit frictional load losses and ball-and-clevis joints on the side load cells. FIG. 15 shows the MUPHyN thruster mounted in the 4-DOF test stand. The axial load cells on the MUPHyN test stand were calibrated using conventional single axis methods. However, the test stand was calibrated for side force, roll, and yaw using a simultaneously multivariable calibration method similar to the one previously described by Eilers et al. See Eilers, S. D., Wilson, M., and Whitmore, S., Analytical and Experimental Evaluation of Aerodynamic Thrust Vectoring on an Aerospike Nozzle,” 46^{TH} AIAA/ASME/SAE/ASEE JOINT PROPULSION CONFERENCE AND EXHIBIT, Nashville, Tenn., 2010. The method was modified from that cited above to allow drift of the bias during calibration whereas the previous method assumed zeroed reference data. The resulting side force calibration had a 95% uncertainty error of approximately +0.038 N or about +0.5% of the nominal side force value.

### V. Hot Fire Test Results

A. Primary Plenum Flow Test Results

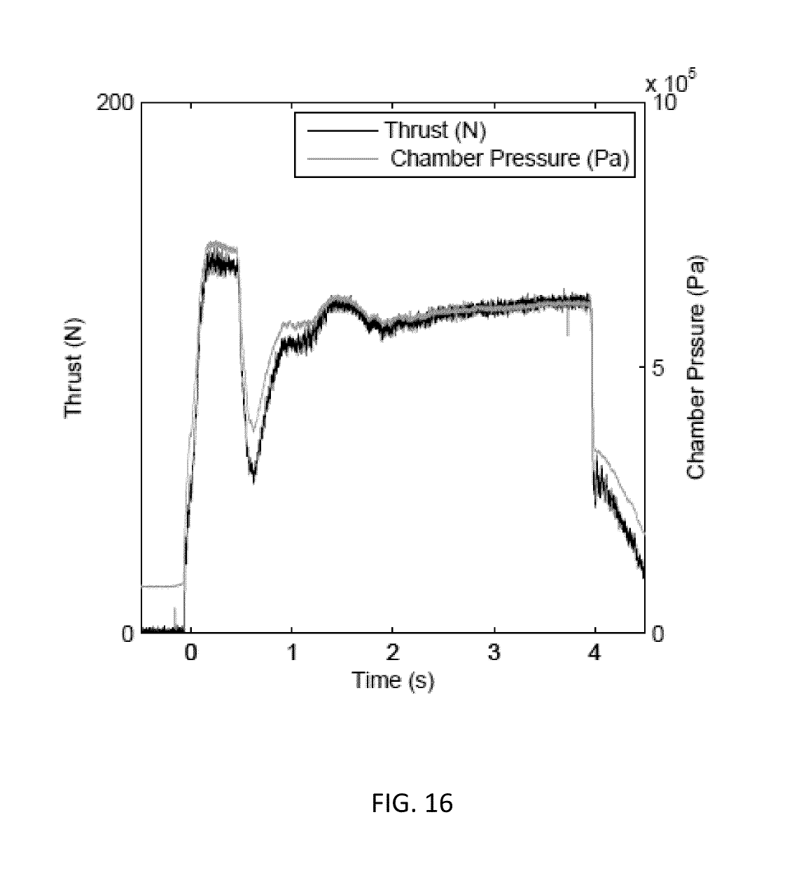

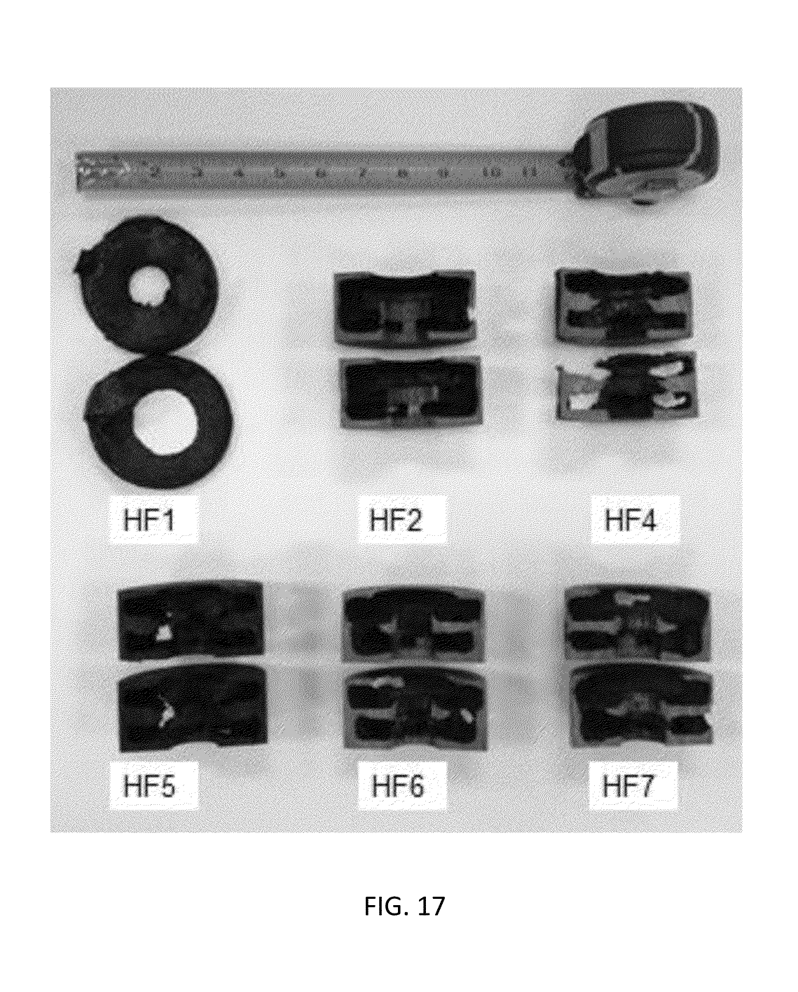

FIG. 16 presents pressure and thrust time-history profiles for a typical MUPHyN burn. After the initial startup transient, the motor achieves a steady-state thrust level that is within 5% of the design value of 120 N. Obviously, the Isp's listed in Table 6 are significantly lower than would be expected for a well-tuned hybrid rocket motor. There are two plausible explanations for this lowered performance: (1) this initial series of tests was designed to have a higher than desirable oxidizer mass flow rate of oxidizer to ensure sufficient cooling, and (2) the fuel regression rate was much higher than initially anticipated. The high regression rate is presumably due to centrifugal flow effects produced by the helical port in the ABS fuel grains. FIG. 17 contains photographs of each of the burned fuel grains for each of the test fires listed in Table 6.

TABLE 6
MUPHyN Test Fire Summary

| | Burn | | Total | | | |
|---|---|---|---|---|---|---|
| Test | Time | Isp | Impulse | O/F | Secondary | Approx. Ox. |
| No | (s) | (s) | (Ns) | Ratio | Injectant | Flow Rate |
| HF1 | 3 | 137 | 487 | 3.16 | None | 0.088 |
| HF2 | 3 | 122 | 370 | 4.14 | Helium | 0.077 |
| HF4 | 3 | 128 | 400 | 3.13 | Helium | 0.077 |
| HF5 | 3 | 106 | 320 | 3.16 | Nitrogen | 0.072 |
| HF6 | 4 | 144 | 450 | 3.35 | Nitrogen | 0.060 |
| HF7 | 4 | 142 | 469 | 3.38 | Oxygen | 0.063 |

B. Regenerative Cooling Test Results

During each of the MUPHyN test firings there was no notable erosion on the aerospike surface, and the regenerative cooling system maintained the aerospike and the supporting injector structure well within material temperature limits. The combustion frame temperature is estimated to exceed 2800 C.

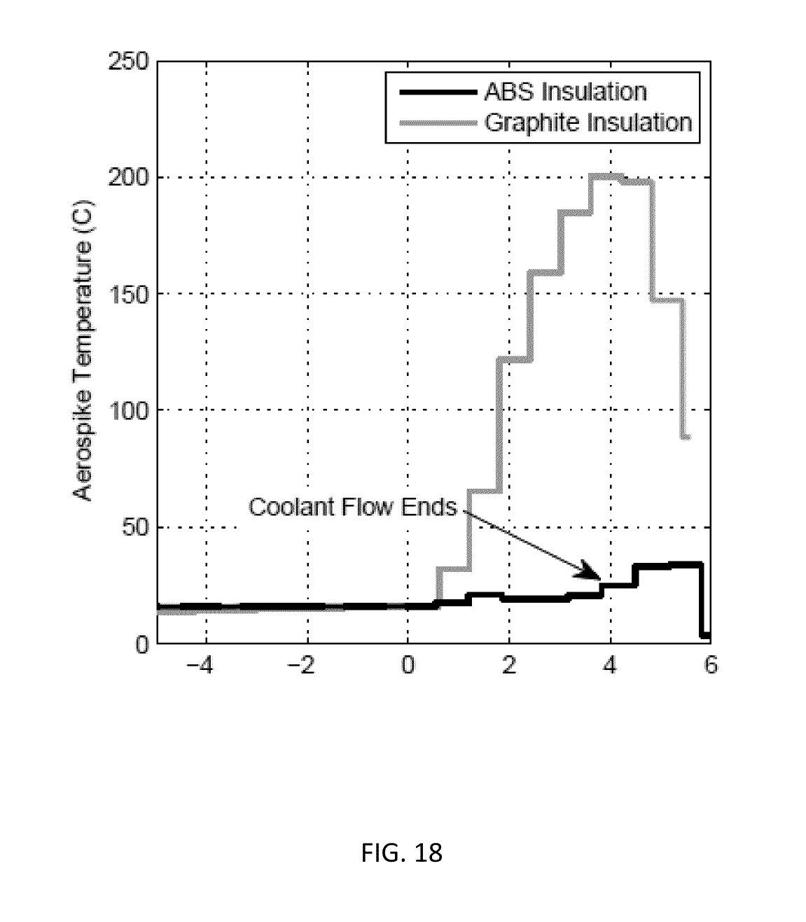

FIG. 18 presents temperature profiles from two hot-fire tests performed with a thermocouple embedded just inside of the nozzle coolant channels. A large nozzle temperature difference between the two tests is noted. The initial MUPHyN tests used a graphite insulator below the aerospike nozzle. In later tests, this insert was replaced with ABS fuel, which substantially lowered the total heat transfer into the fuel grain.

For the tests with ABS insulation, the aerospike temperature presented in FIG. 18 shows reasonable agreement with the predicted aerospike temperature discussed above and shown in FIG. 10 for a net heat flux of about 3500 Watts. This result suggests that the heat transfer models used in this analysis are a reasonable approximation.

C. Effects of Fuel Grain Geometry on Fuel Regression Rate and Motor Performance

As seen in FIG. 17, the original MUPHyN helix demonstrated much higher fuel regression rates than expected and low combustion efficiencies (as seen by the low specific impulses). In addition, the oxidizer flow rate was constrained by requirements to maintain a high safety factor on coolant capacity, not thrust level or desired oxidizer mass flux. The test HF5 showed ample cooling capacity once the center aerospike support was insulated with ABS instead of graphite. This allowed more flexibility in nitrous oxide flow rates. For the next two tests, the main oxidizer flow rate was decreased by approximately 25% which allowed for lower oxidizer mass fluxes in the fuel grain. This, in turn, allowed for greater flexibility in fuel grain design.

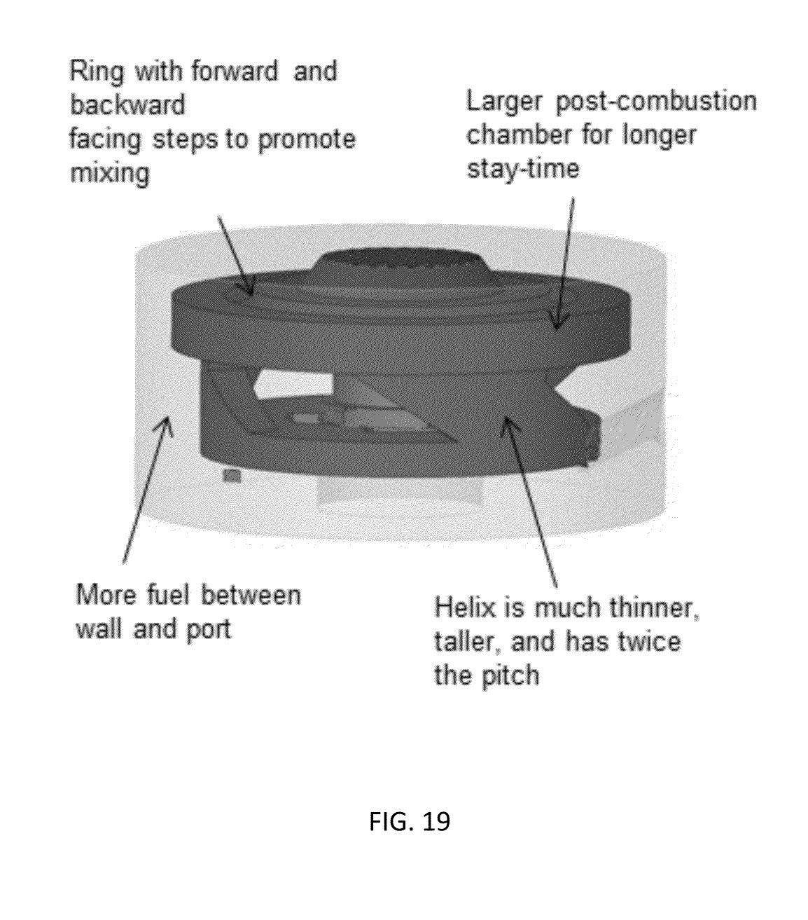

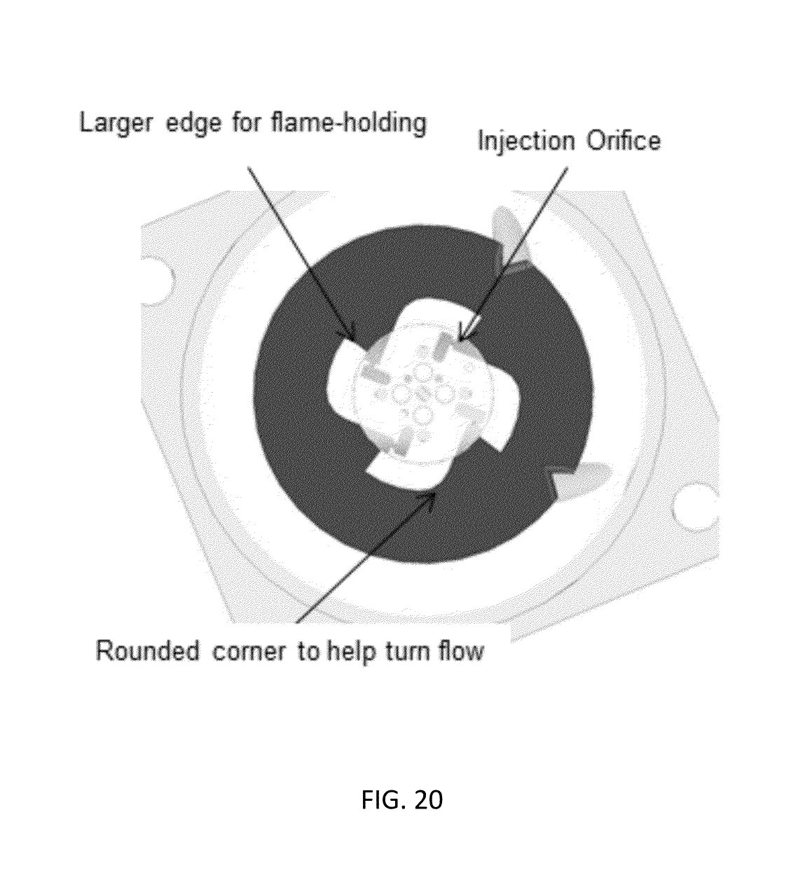

For HF6 and HF7, the double helix design was replaced with a triple helix design with much thinner and taller combustion chambers. This geometry is shown in FIG. 19 and the geometry for all of the test fires is listed in Table 7. The thinner triple helix promotes more mixing of the center port than the double helix design and results in more fuel between the combustion chamber and the motor wall, which allows for longer burn times. The pre-combustion chamber was also designed with fuel structures designed to promote flame holding and to turn the oxidizer streams, preventing their direct impingement on the opposite fuel wall. FIG. 20 shows these fuel structures.

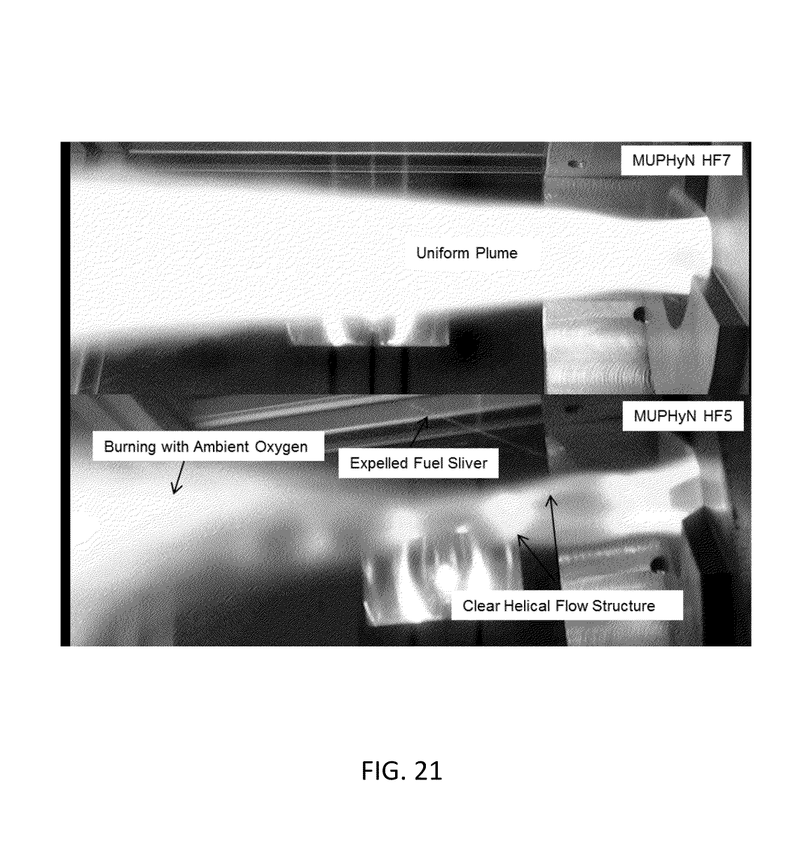

As a result of this redesign, the specific impulse for HF6 and HF7 increased by approximately 16% over the previous test fires. The motor plume for these tests was also distinctly different from the previous tests. FIG. 21 shows the differences in flow features between test HF5 and HF7. The plume in HF7 is much more uniform and the unmixed helical flow pattern exhibited by the previous tests is absent. It is believed by the authors that further reduction in the oxidizer mass flow rate would continue this trend, further increasing the MUPHyN specific impulse.

TABLE 7
Fuel Grain Geometry Summary

| | Port | | | Initial | |
|---|---|---|---|---|---|
| Test | Area | Helical Radius | Pitch (cm) | Surface Area | Number of |
| HF1 | 1.59 | 2.74 | 3.81 | 222 | 2 |
| HF2 | 1.54 | 2.73 | 3.81 | 2.11 | 2 |
| HF4, HF5 | 1.59 | 2.74 | 6.35 | 190 | 2 |
| HF6, HF7 | 55.2 | 2.91 | 12.7 | 194 | 3 |

D. Thrust Vectoring Test Results

Thrust vectoring tests have been completed with nitrogen, helium, and oxygen as secondary injectants. Table 8 summarizes the thrust vectoring test results with parameters including side-force Isp, amplification factor, and equivalent thrust vector angle.

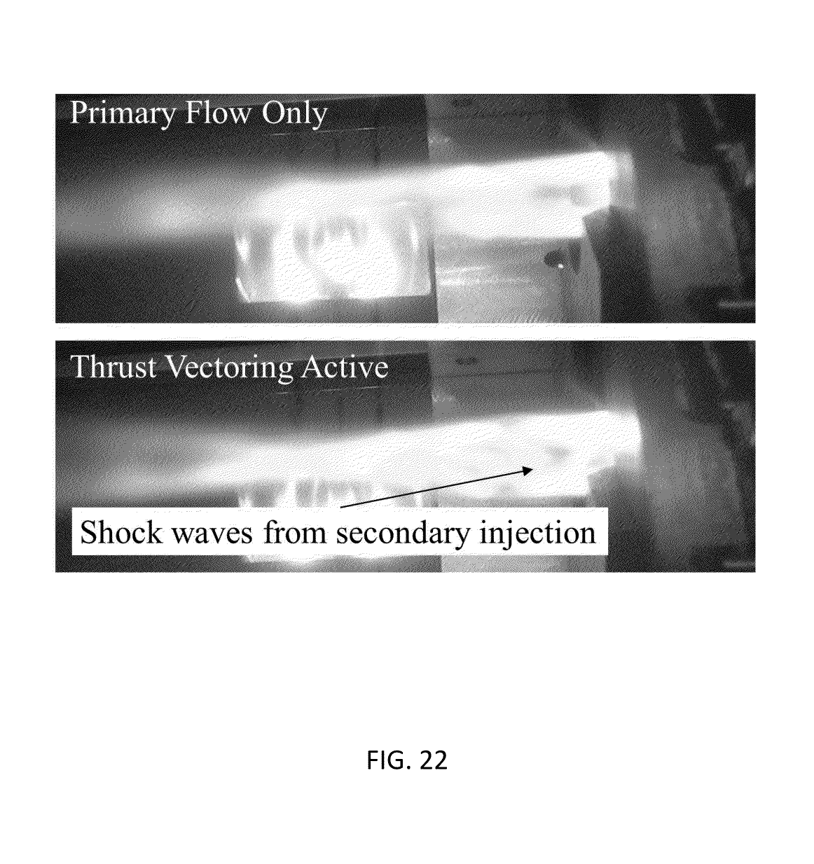

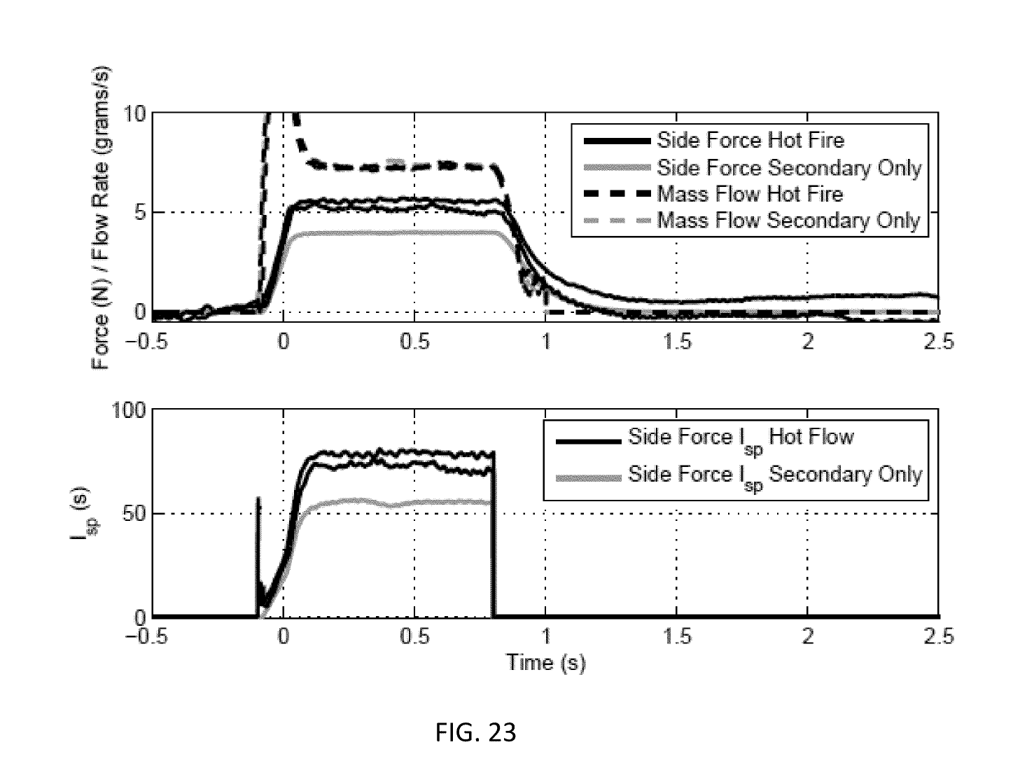

As discussed previously, secondary injection on an aerospike nozzle creates a localized bow shock in front of the injection site and increases the total generated side force. FIG. 22 shows the MUPHyN plume with and without secondary injection active. When the secondary injection port is active, the shock waves created by secondary flow interaction ahead of the injection site are clearly visible.

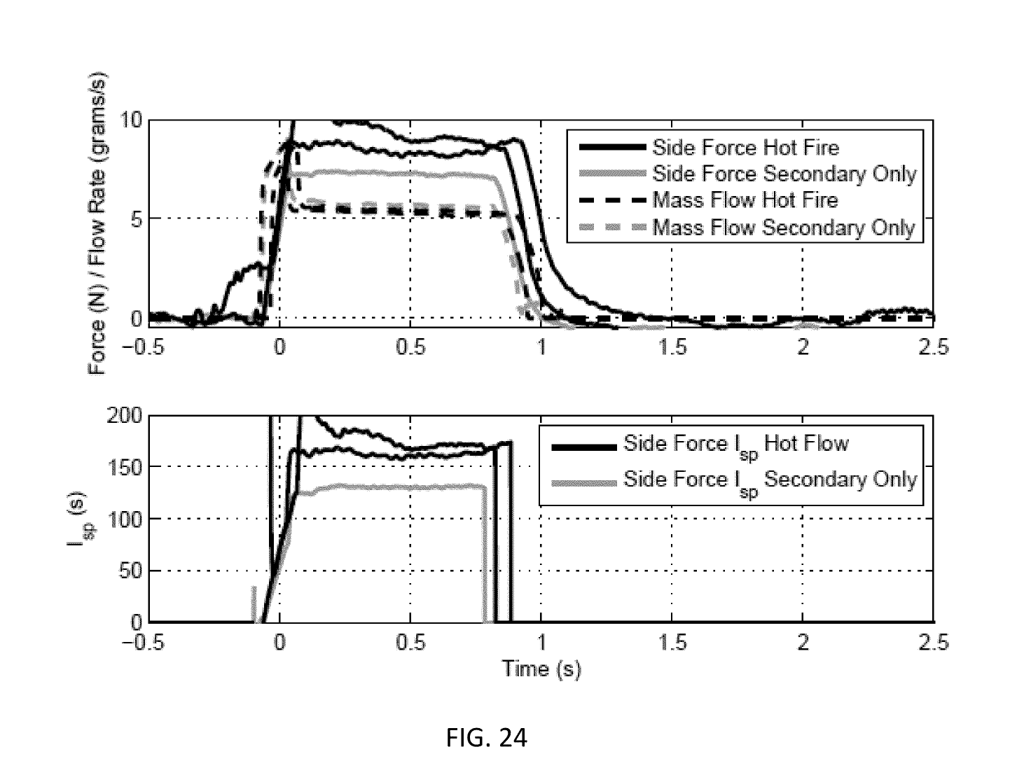

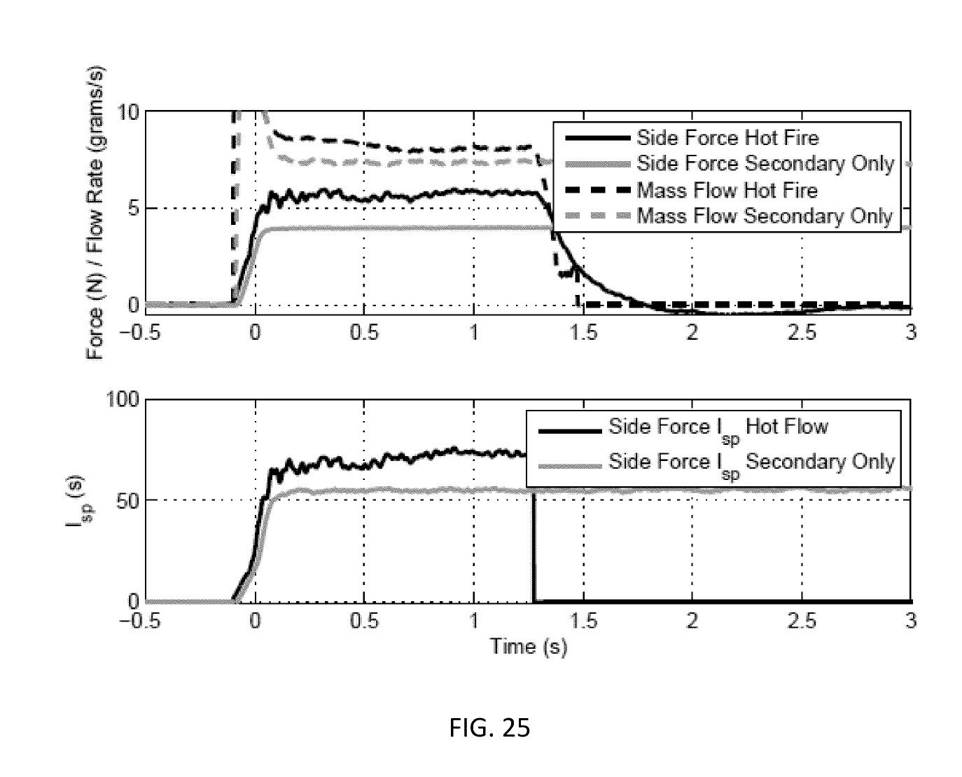

FIGS. 23 through 25 plot the side force, specific impulse, and mass flow rates achieved using gaseous nitrogen, helium, and oxygen, respectively. The side force impulses appear to be both crisp and repeatable. The total thrust vector angle for tests with helium was substantially higher than those with nitrogen and oxygen due to higher injection pressures higher total mass flow rates. The higher achieved side-force specific impulse for helium is likely a result of the significantly lower molecular weight of the injectant. The amplification factor for oxygen was not substantially higher than that shown for nitrogen, which implies that combustion of the oxygen with unreacted fuel in the separated region before the secondary injection port does not significantly influence thrust vectoring efficiency. The estimated uncertainty in side-force specific impulse calculations is approximately 2.0 seconds.

The hot-gas side force amplification factor (133%) is only slightly lower than the 140% amplification factor demonstrated by Eilers et al. for cold flow tests using CO2 gas. Eilers, S. D., Wilson, M., and Whitmore, S., Analytical and Experimental Evaluation of Aerodynamic Thrust Vectoring on an Aerospike Nozzle, 46^{TH} AIAA/ASME/SAE/ASEE JOINT PROPULSION CONFERENCE & EXHIBIT, 2011.

TABLE 8
Thrust Vectoring Test Summary

| | Secondary | Isp with | | | |
|---|---|---|---|---|---|
| | Flow Only | Primary Flow | Amplification | Thrust Vectoring | Injectant Static |
| Injectant | Isp (s) | (s) | Factor | Angle (deg) | Pressure (MPa) |
| Nitrogen | 51.0 | 67.1 | 1.32 | 1.95 | 3.5 |
| Helium | 121.3 | 165.5 | 1.36 | 3.63 | 5.7 |
| Oxygen | 55.2 | 73.1 | 1.32 | 2.63 | 3.5 |

### VI. Conclusion

The authors of the present disclosure have designed and tested a novel Multiple Use Plug Hybrid (for) Nanosats (MUPHyN) that may be used for CubeSat and nanosat-sized spacecraft. The MUPHyN thruster offers several features that are uniquely suited for nanosat, and particularly CubeSat, applications. Benefits of embodiments of the present disclosure may include: (1) a highly compact, truncated aerospike nozzle, (2) non-mechanical thrust vectoring using secondary fluid injection on the aerospike nozzle, (3) a hybrid fuel grain with an embedded helical port, or (4) a non-pyrotechnic ignition system.

The MUPHyN system provides attitude and velocity control using secondary injection thrust vectoring without mechanical nozzle gimbals or additional reaction control thrusters. Both larger impulse ΔV and small impulse attitude control and proximity operations burns can be performed with the same system.

This synthesis of technologies is unique to the MYPHyN thruster design and no other commercial or government entity has produced comparable work that has been published in open literature. The resulting system is compact, non-toxic, non-explosive, and uses non-pyrotechnic means for reliable motor ignition.

When fully developed, this enhanced propulsive capability will enable multiple CubeSats to be deployed simultaneously by a single launch vehicle and be independently repositioned, a key enabling technology for multi-point measurement science missions.

The initial series of MUPHyN motor test fires have demonstrated stable combustion and shown thrust vectoring effectiveness that closely reproduces previously demonstrated results achieved during cold flow testing. The regenerative cooling system has performed effectively in all test fires to date.

The achieved main flow specific impulses were lower than expected. There are two plausible explanations for this lowered performance: (1) this initial series of tests was designed to have a higher than desirable oxidizer mass flow rate of oxidizer to ensure sufficient cooling, and (2) the fuel regression rate was much higher than initially anticipated. The high regression rate is presumably due to centrifugal flow effects produced by the helical port in the ABS fuel grains. These higher-than-expected regression rates resulted in O/F ratios significantly lower than the levels desired for good combustion efficiency. A MUPHyN design with lower oxidizer flow rates and a fuel grain with geometry that induced additional mixing showed significant improvement in specific impulse and it is believed that this trend would continue for even lower flow rates.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A hybrid rocket motor comprising:
an aerospike nozzle configured for secondary fluid injection for non-mechanical thrust vectoring;
a hybrid fuel grain surrounded by a casing, the fuel grain comprising acrylonitrile butadiene-styrene;
a non-pyrotechnic ignition system.

2. The rocket motor of claim 1, wherein the hybrid rocket motor is configured to fit within in a 1U section of a CubeSat bus.

3. The plug hybrid rocket motor of claim 1, wherein the aerospike nozzle is configured for six degree-of-freedom attitude and velocity control.

4. The hybrid rocket motor of claim 1, further comprising injectors pneumatically connected to the aerospike nozzle and positioned within the casing.

5. The hybrid rocket motor of claim 4, further comprising an aerospike nozzle configured to be re-generatively cooled from the injectors.

6. The hybrid rocket motor of claim 1, wherein the hybrid fuel grain comprises an embedded helical fuel port.

7. The hybrid rocket motor of claim 6, wherein a flow path of the embedded helical fuel port is longer than an overall length of the hybrid fuel grain.

8. The hybrid rocket motor of claim 6, wherein the helical fuel port is configured to maintain a total oxidizer-to-fuel ration low during an entire motor burn.

9. The hybrid rocket motor of claim 6, wherein the helical fuel port comprises two or more helical ports.

10. The hybrid rocket motor of claim 6, wherein the helical fuel port comprises three or more helical ports.

11. The hybrid rocket motor of claim 1, wherein the non-pyrotechnic ignition system is configured for multiple restarts with a single hydrocarbon fuel grain.

12. The hybrid rocket motor of claim 1, wherein the non-pyrotechnic ignition system is configured to ignite the hybrid fuel grain with less than 240 Watts and a total energy consumption less than 5 Joules.

13. The hybrid rocket motor of claim 1, further comprising an inner throat and nozzle plug configured to be regeneratively cooled.

14. The hybrid rocket motor of claim 13, wherein the hybrid rocket motor is configured to flow nitrous oxide through a base to the throat and then down and out tangential injectors into a combustion chamber.

15. A method for making a plug hybrid rocket motor, the method comprising manufacturing a hybrid fuel grain with an embedded helical port using a fused deposition modeling rapid prototyping machine.
